(19) United States
(12) Patent Application Publication
(10) Pub. No.: US 2009/0122854 A1
(43) Pub. Date: May 14, 2009

(54) FREQUENCY DOMAIN EQUALIZATION WITH TRANSMIT PRECODING FOR HIGH SPEED DATA TRANSMISSION

(75) Inventors: Yu Zhu, Hong Kong (CN); Khaled Ben Letaief, Hong Kong (CN)

Correspondence Address: AMIN, TUROCY & CALVIN, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 11/939,684

(22) Filed: Nov. 14, 2007

(51) Int. Cl. H04L 27/01

(52) U.S. Cl. 375/232; 375/260

(57) ABSTRACT

Various embodiments of multi input multi output (MIMO) communication systems include a transmit Tomlinson-Harashima Precoding (THP) technique and a single carrier frequency domain equalization (SC-FDE) technique. Parallel THP-FDE and successive THP-FDE are proposed based on the minimum mean square error (MMSE) criterion. For the successive THP-FDE technique, where all transmit streams are subsequently precoded, both suboptimal and optimal MMSE ordering algorithm are set forth. Since the feedback processing is performed at the transmitter, no error propagation problem exists in the THP-FDE MIMO techniques, yielding significant performance improvements over conventional FDE MIMO techniques. Applying channel prediction and THP compensation techniques can also further enhance performance.

### TECHNICAL FIELD

The subject disclosure relates generally to multi-input multi-output (MIMO) wireless communications, and more particularly, to employing frequency domain equalization (FDE) with Tomlinson-Harashima precoding (THP) for single carrier broadband MIMO wireless communication systems.

### BACKGROUND OF THE INVENTION

MIMO technology involves employing multiple antennas at both the transmitter side and the receiver side in a wireless communication system. Such technology has recently received significant recognition as a fundamental technique for increasing diversity gain and enhancing system capacity in wireless communication systems. However, performance of MIMO systems can become severely degraded when operating over a multipath fading channel.

Conventionally, orthogonal frequency-division multiplexing (OFDM) techniques have been used to mitigate this performance degradation by converting a frequency-selective MIMO channel into a set of parallel frequency-flat fading MIMO channels. However, OFDM has several inherent disadvantages. For example, the powers of signals transmitted in a system utilizing OFDM often have high peak-to-average ratios (PARs). In addition, it is known that OFDM is sensitive to carrier frequency offsets (CFOs).

Another conventional approach that has been used to mitigate performance degradation due to multipath fading is single carrier frequency domain equalization (SC-FDE). SC-FDE systems perform similarly to OFDM systems, and even better in some cases, while having about the same signal processing complexity. The single-carrier transmission used in SC-FDE has been adopted as one of the air interface standards of IEEE 802.16 for fixed broadband wireless access systems. It has also been considered for use in the Third Generation Partnership Project—Long Term Evolution (3GPP-LTE) protocol. Additionally, SC-FDE systems allow operation with fewer inherent disadvantages than OFDM systems. For example, because of its single carrier transmission, FDE systems have lower peak-to-average power ratios and reduced sensitivity to CFOs compared to OFDM systems. In this regard, the use of FDE with MIMO technology increases capacity of the system over frequency selective channels while inheriting the same benefits of single input single output (SISO) channels.

The FDE approach has also been extended to single carrier frequency domain linear equalization (FD-LE), which is based on a minimum mean-square-error (MMSE) criterion for MIMO systems, or so called Zero-Forcing. FD-LE is used in MIMO systems to perform space, or spatial, division multiple access (SDMA).

SC-FDE has further been extended to hybrid time-frequency domain decision feedback equalization (FD-DFE) for MIMO systems, where a feedforward FDE is used in connection with a group of time domain feedback filters to help eliminate any post-cursor inter-symbol interference (ISI) and co-channel interference (CCI) of the data streams. In another variation of FD-DFE adapted from conventional layered spatial-time domain equalization techniques, a layered spatial-FDE structure is utilized, employing a basic FDE at multiple stages and detecting multiple data streams according to the layered approach. Layered spatial-FDE has also conventionally been combined with iterative processing, where an iterative block DFE is utilized in a layered FDE MIMO system.

Still other conventional variations on FDE systems include noise predictive FDE (FDE-NP) MIMO structures, which are equivalent to FD-DFE systems in the MMSE sense. While it has been shown that FDE-NP systems have a lower complexity and a more flexible receiver design than FD-DFE systems, the focus of the technique is restricted to the receiver.

In this regard, all of the above-described conventional FDE structures have focused on the signal processing at the receiver. For instance, FD-LE techniques, hybrid time-FD-DFE techniques, and FDE-NP techniques each focus processing on the receiver side. For a specific example of the kinds of problems that result from such receiver side focus, one notable, but unaddressed problem with FD-DFE and FDE-NP is that the feedback symbols are drawn from decisions made on the receiver side, which frequently results in error propagation and performance degradation.

Accordingly, the outstanding deficiencies in the state of the art have made it desirable to seek improved MIMO systems and techniques. The above-described deficiencies of current MIMO systems employing FDE structures and variants thereof are merely intended to provide an overview of some of the problems of conventional systems, and are not intended to be exhaustive.

### SUMMARY OF THE INVENTION

The following presents a simplified summary in order to provide a basic understanding of some aspects improved MIMO systems disclosed herein. This summary is not an extensive overview and it is intended neither to identify key or critical elements of the invention nor to delineate the scope of operation of any of the structures or methods discussed herein. Its sole purpose is to present some concepts in a simplified form as a prelude to the more detailed description that is presented later.

The subject application provides parallel and successive THP-FDE MIMO techniques have been described, where error propagation problems can be avoided by using transmit preceding. In the successive THP-FDE technique, an optimal ordering algorithm can be adopted in the sense of minimizing the maximum of MMSEs. The THP-FDE MIMO techniques offer significant performance improvements compared to conventional FDE MIMO techniques. Optionally, by applying channel prediction and THP compensation, the THP-FDE techniques become nearly insensitive to channel variations and thus represent practical FDE structure for future broadband wireless systems.

In one embodiment, a system is provided that facilitates channel equalization in MIMO communication system that includes a transmitter side component including a preceding component that pre-codes transmitted data streams by optimizing with respect to minimum mean-square-error (MMSE) values determined for the transmitted data streams and a receiver side component including a frequency domain equalizer (FDE) component that equalizes the transmitted data streams.

To the accomplishment of the foregoing and related ends, certain illustrative aspects are described herein in connection with the following description and the drawings. These aspects are indicative, however, of but a few of the various ways in which the various principles described herein may be employed and the scope of operation of such aspects is intended to include all such ways and their equivalents. Other advantages and features will also be apparent from the following detailed description of the invention when considered in conjunction with the drawings.

### BRIEF DESCRIPTION OF THE DRAWINGS

FIGS. 1 and 2 are high-level block diagrams of multiple-input multiple-output communication systems in which THP-FDE techniques can be applied;

FIGS. 3 and 4 are block diagrams of exemplary non-limiting implementations of THP-FDE MIMO communication systems;

FIG. 5 provides the BER performance comparison for the THP-FDE technique with the conventional FD-LE and FD-DFE techniques in a SISO system as a function of E_{b}/N₀ with Quadrature Phase Shift Keying (QPSK) and 16QAM modulations along with the modified Chernoff approximation (MCA);

FIG. 6 generally illustrates BER versus normalized Doppler frequency for different normalized channel estimation MSEs in the THP-FDE SISO system with QPSK modulation when E_{b}/N₀=16 dB;

FIG. 7 generally illustrates BER performance results of the AR-model channel prediction and the THP compensation for a THP-FDE SISO system with QPSK modulation when E_{b}/N₀=16 dB;

FIG. 8 generally illustrates a BER performance comparison for the parallel and successive THP-FDE techniques with the conventional FD-LE and FD-DFE techniques in a 2-by-2 MIMO system with QPSK modulation;

FIG. 9 generally illustrates a BER performance comparison for the parallel and successive THP-FDE techniques with the conventional FD-LE and FD-DFE techniques in a 2-by-2 MIMO system with 16QAM modulation;

FIG. 10 generally shows BER MCA results of the successive THP-FDE technique with different ordering algorithms for different MIMO systems, e.g., 2 by 2 MIMO systems and 4 by 4 MIMO systems;

FIG. 11 is a block diagram showing various aspects of a parallel THP-FDE MIMO communication system;

FIG. 12 is a block diagram showing various aspects of a successive THP-FDE MIMO communication system;

FIG. 13 is a flowchart of a method for communicating according to various non-limiting aspects of parallel THP-FDE MIMO communication systems;

FIG. 14 is a flowchart of a method for communicating according to various non-limiting aspects of successive THP-FDE MIMO communication systems;

FIG. 15 is a block diagram representing an exemplary non-limiting computing system or operating environment in which the present invention may be implemented; and

FIG. 16 illustrates an overview of a non-limiting packet based network environment suitable for service by embodiments of the present invention.

### DETAILED DESCRIPTION OF THE INVENTION

### Introduction

Various aspects are now described with reference to the drawings, wherein like reference numerals are used to refer to like elements throughout. In the following description, for purposes of explanation in some instances, specific details may be set forth in order to provide a more thorough understanding; however, where applicable, it can be appreciated that such specific details are optional or implementation-specific, and are not intended as limiting on the scope of any overall or general concepts set forth in the disclosure. In other instances, well-known structures and devices may be shown in block diagram form to facilitate description.

As used in this application, the terms “component,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. As another example, a component may comprise one or more logical modules implemented on a hardware device such as a field-programmable gate array (FPGA), a digital signal processor (DSP), an application-specific integrated circuit (ASIC), and/or any other integrated circuit device or suitable hardware device. By way of illustration, both an application running on a server and the server can be a component. One or more components may reside within a process and/or thread of execution and a component may be localized on one computer and/or distributed between two or more computers.

Also, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. The components may communicate via local and/or remote processes such as in accordance with a signal having one or more data packets (e.g., data from one component interacting with another component in a local system, distributed system, and/or across a network such as the Internet with other systems via the signal).

Further, as used in the subject disclosure, capital letters denote entities in the frequency domain and lowercase letters represent entities in the time domain. Bold letters denote matrices and column vectors. In this regard, I_{N} denotes an N-by-N identity matrix and 0_{N×M} denotes an N-by-M zero matrix. The operator (.)modN denotes the modulo-N operation. Notation └.┘ represents the largest integer less than or equal to a real number. Re(.) and Im(.) denote the real and imaginary parts of a complex number, respectively. The superscripts (.)^{T}, (.)^{*}, and (.)^{H} denote transpose, complex conjugate, and complex conjugate transpose, respectively. Finally, tr{.} denotes the trace of a square matrix and E{.} denotes the expectation operation.

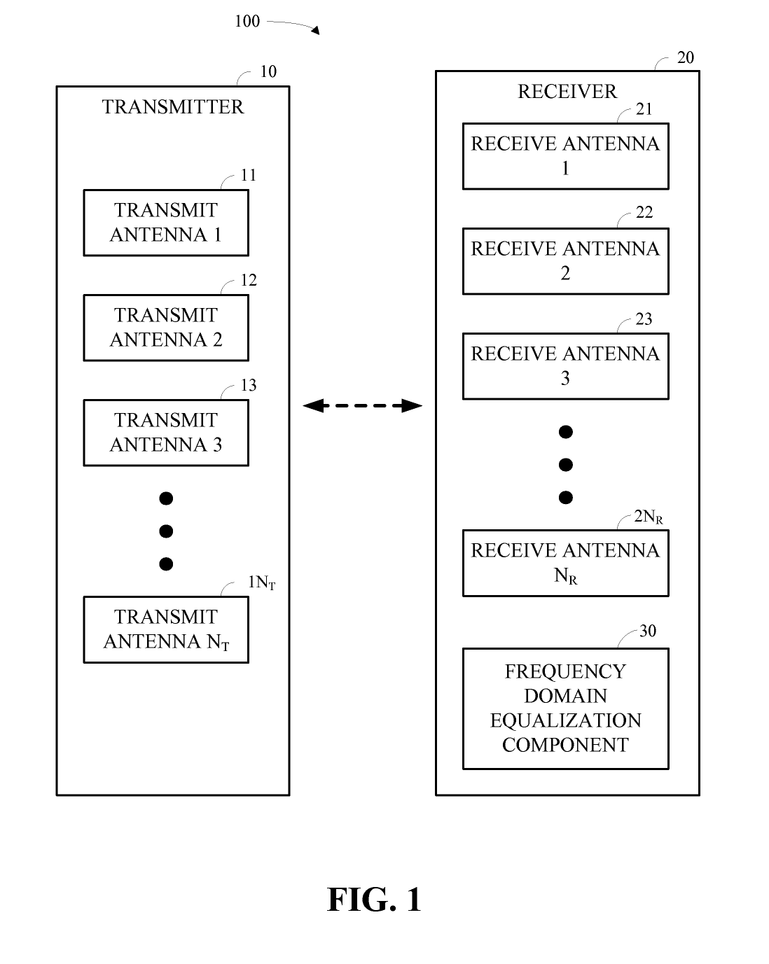

As mentioned in the background, conventional FDE structures tend to focus on signal processing and decision-making that takes place at the receiver, which can cause error propagation and performance degradation. For instance, referring to FIG. 1 for additional context, a high-level block diagram of a multiple-input multiple-output (MIMO) communication system 100 employing an FDE component 30 is illustrated. MIMO system 100 includes a transmitter component 10 having N_{T} transmit antennas 11, 12, 13, . . . , 1N_{T}. Data streams transmitted by the transmit antennas 11, 12, 13, . . . , 1N_{T} may travel through frequency selective channels and may then be received at a receiver 20 having N_{R} receive antennas 21, 22, 23, . . . , 2N_{R}.

Receiver 20 can thus include an equalization component 30 to mitigate signal degradation present in the data streams received from the transmitter 10 due to multipath fading. For instance, the equalization component 30 can utilize FDE-NP, wherein linear equalization is performed on the received signals in the frequency domain and then noise prediction is performed on the linearly equalized data streams in the time domain. FDE techniques other than FDE-NP can also be substituted or combined in equalization component 30, however, as mentioned, such emphasis on the receiver side can lead to undesirable error propagation.

Accordingly, considering transmitter side techniques, in the case of time domain equalization (TDE), in one example, employing the Tomlinson-Harashima Precoding (THP) at the transmitter eliminates the error propagation problem. THP has the same ability as DFE in removing ISI and, as described for various embodiments herein, can be applied to spatial equalization processes in MIMO systems for removing the inter-channel interference (ICI). In this regard, as discussed herein, combined with the techniques of equalization component 30, the THP precoding structure can be extended into multipath MIMO channels, where THP is used for the removal of both temporal and spatial interferences. The balance of receiver and transmitter side techniques achieves performance advantages that far surpass receiver side only techniques.

### THP-FDE MIMO Systems

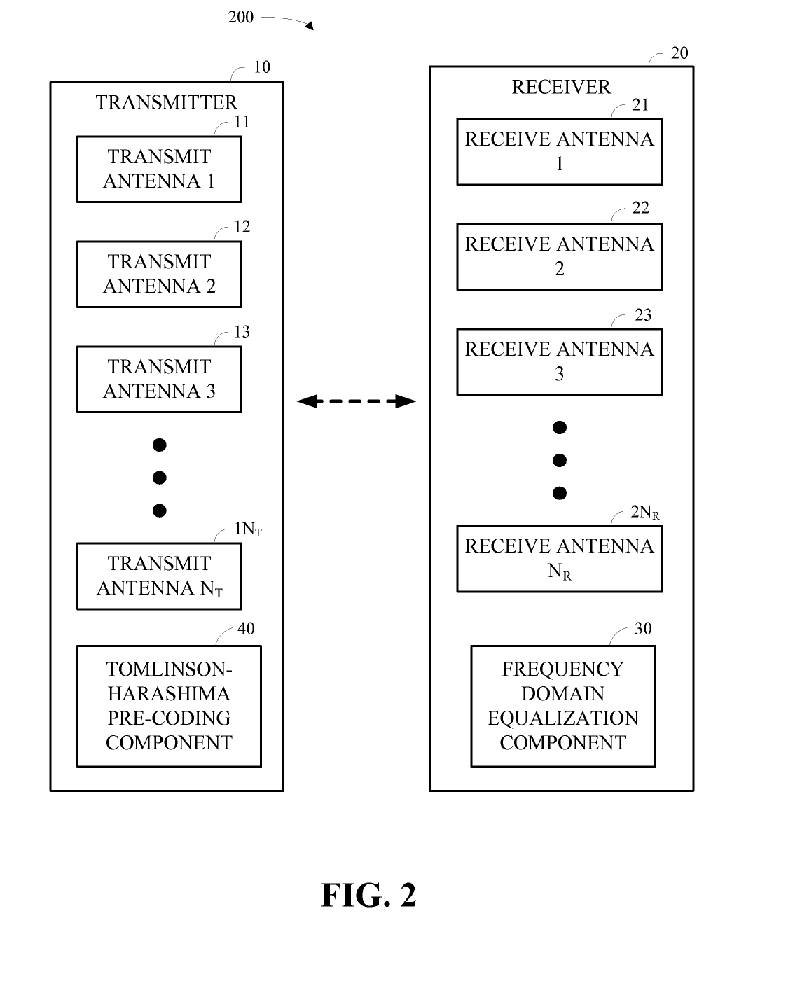

Achieving a host of synergies and advantages, various MIMO techniques embodiments are described herein combining transmit and receive side optimizations including THP techniques on the transmit side and FDE techniques on the receiver side. Accordingly, as shown in FIG. 2, in addition to FDE component 30, a system 200 in accordance with the invention includes a THP component 40.

Two non-limiting alternate embodiments are referred to herein as parallel THP-FDE and successive THP-FDE, respectively. Both parallel and successive THP-FDE techniques include a THP 40 at the transmitter and an FDE 30 at the receiver. In contrast to previous THP techniques in TDE, where the precoding is done continuously for a whole information stream, information symbols for THP-FDE systems 200 are divided into blocks and precoded block-by-block. Few zero symbols are inserted at the end of precoded symbols in each block so that the relationship between the input and output signals of THP can be simply expressed in the frequency domain. The coefficients of THP and FDE are then derived based on MMSE criterion.

Achieving benefits over conventional systems, in various embodiments, the receive equalizer 30 is performed in the frequency domain so that the advantage of lower computational complexity of FDE over TDE is maintained. Furthermore, the number of feedback taps of THP 40 can be freely chosen, enabling a balance between complexity and performance to be achieved for a given application or scenario. For instance, in successive THP-FDE, the transmit streams are ordered and precoded sequentially. To investigate the effects of different ordering algorithms on the performance of successive THP-FDE, an ordering algorithm can be used that leads to the global optimal order that minimizes the maximum of MMSEₚ over all possible orders, where MMSEₚ denotes the MMSE value of the p-th transmit stream in an order. Then, the optimal ordering algorithm is compared with a suboptimal MMSE ordering algorithm and a random-ordering algorithm to illustrate the performance benefits of optimal ordering. In some cases, the suboptimal ordering algorithm performs adequately.

Since the error propagation problem is avoided by THP, the THP-FDE techniques described herein achieve significant improvement over conventional FDE MIMO techniques. Furthermore, a modified Chernoff approximation (MCA) can be used to analyze the performance of the various THP-FDE MIMO systems. Numerical results demonstrate that results found by the MCA are substantially identical to the true simulated results.

In systems with THP, it is desirable for the transmitter to have precise knowledge of channel state information (CSI), which may be difficult to obtain in wireless systems because of channel variations. With the various techniques described below, the receiver estimates the channel based on the use of training sequences. Instead of sending estimates to the transmitter, assuming the feedback channel has no error, but a certain delay, the receiver first predicts the channel by using an autoregressive (AR) model and then optimizes the parameters in the least squared (LS) sense. The receiver then feeds back the predicted CSI to the transmitter. Any mismatch between the predicted CSI and the true channel value can be further compensated at the receiver. As numerical results show, by using channel prediction and THP compensation techniques, THP-FDE MIMO systems become almost insensitive to channel variation in the practical range of Doppler frequency.

As an overview of what follows below, first, a system model for the THP-FDE MIMO systems is described. Then, parallel and successive THP-FDE MIMO designs and techniques are described. Next, the system performance is evaluated and the CSI mismatch problem is discussed in more detail. Then, via simulated results, the efficacy of the various THP-FDE MIMO systems described herein is demonstrated. Further, a proof of the optimality of an ordering algorithm described herein is shown, followed by some exemplary, non-limiting operating environments for the various THP-FDE MIMO systems described herein.

### System Model

Herein, as illustrated generally in FIG. 2, a single carrier block transmission is considered in a general MIMO system 200 having transmit component 10 and receive component 20. MIMO system 200 includes N_{T} transmit antennas, such as antennas 11, 12, 13, . . . , 1N_{T}, and N_{R} receive antennas, such as antennas 21, 22, 23, . . . , 2N_{R}, operating over frequency selective channels. While only one transmitter component 10 is illustrated in system 100 for brevity, it can be appreciated that system 100 could include any number of transmitters 10, and similarly for receiver component 20. By way of non-limiting example, transmitter 10 may be an access terminal, user equipment, a mobile device, or any other appropriate transmitting device, equipment, or entity. Additionally, receiver 20 may be a base station, a system access point, a mobile device, or any other suitable receiving device, equipment, or entity.

At the transmitter 10, the original information data is demultiplexed into N_{T} independent streams. Data streams transmitted by each transmit antenna 11, 12, 13, . . . , 1N_{T} can include N symbols, which can be packed and transmitted by each respective transmit antenna 11, 12, 13, . . . , 1N_{T} in a single block.

For each stream, the Nₛ information quadrature amplitude modulation (QAM) symbols, which are drawn from the M²-ary alphabet A={α₁+jα_{Q}|α₁,α_{Q} ε {±1,±3, . . . ,±(M−1)}} where M is an even integer, can be packed and transmitted in one block. Let sₙ=[s_{1,n} . . . s_{N}_{_{T}}_{,n}]^{T} for n=0, . . . , Nₛ−1 denote the vector containing the information symbols of all N_{T} streams. Before modulation and transmission, these symbols are first precoded in the THP block, which includes an N_{fb}-order feedback filter and a group of modulo operators. The transfer function B(z) in the THP block is defined by

$${\sum }_{l = 0}^{{N}_{fb}} {b}_{l} {z}^{- l} ,$$

where the coefficients b₁ are N_{T}-by-N_{T} matrices. The modulo operation to the input complex signal z_{m,n} is taken on the real and imaginary parts separately, which is given by Equation (1):

$${x}_{m , n} = {z}_{m , n} + {a}_{m , n} = {z}_{m , n} - 2 M ⌊ \frac{Re ( {z}_{m , n} )}{2 M} + \frac{1}{2} ⌋ - j2 M ⌊ \frac{Im ( {z}_{m , n} )}{2 M} + \frac{1}{2} ⌋ \qquad ( 1 )$$

where the real (imaginary) of a_{m,n} is the unique integer multiple of 2M for which the real (imaginary) part of the signal after the modulo operation is within (−M, M]. Let σₛ² denote the variance of the information QAM symbols which is equal to 2(M²−1)/3. For a large value of M, the real (imaginary) part of the precoded symbols x_{m,n} is approximately independent and uniformly distributed on (−M, M], regardless of the choice of B(z). Thus, σₓ², which is the variance of the precoded symbols, is approximately equal to 2M²/3. By comparing the values of σₛ² and σₓ², it can be found that more power is needed to send the precoded symbols. However, this power penalty is negligible for a large value of M.

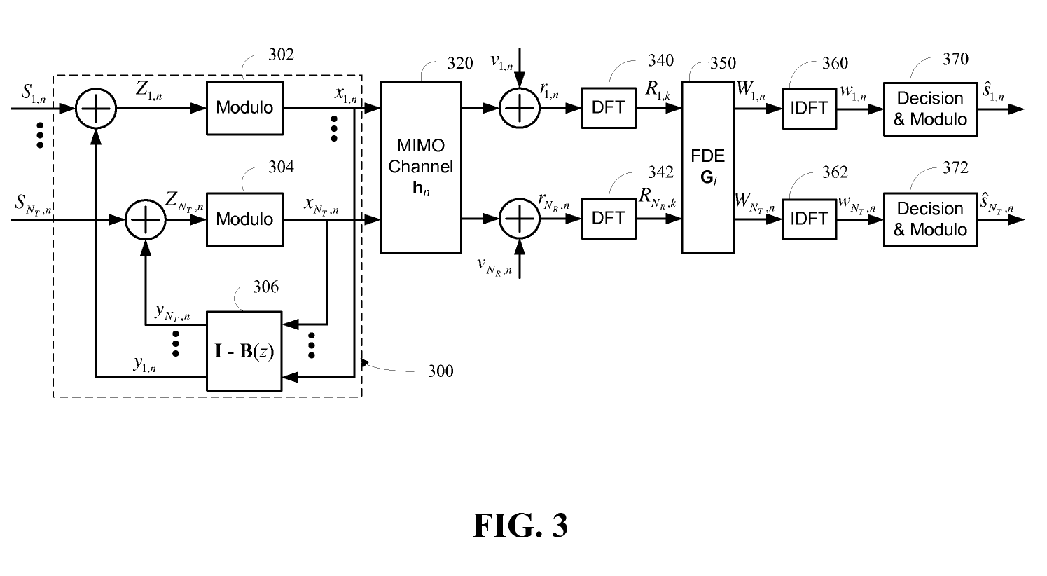

FIG. 3 is an exemplary non-limiting system diagram for THP-FDE signal processing techniques described herein. THP component 300 includes sub-processing block 306 and modulo operators 302 and 304 as depicted. The output of THP component 300 is transmitted via MIMO channel 320. In contrast to previous THP techniques, where preceding has been performed continuously for a whole information stream, each original information block is precoded separately in the THP-FDE techniques described herein. The state of the feedback filter is initialized by adding N_{fb}-length zeros at the end of the sequence of xₙ. By defining the transmission block length N=Nₛ+N_{fb}, the input-output relation of the THP block 300 is defined in Equation (2):

$${c}_{n} ≡ {s}_{n} + {a}_{n} = {\sum }_{l = 0}^{{N}_{fb}} {b}_{l} {x}_{( n - l ) mod N} \\ n = 0 , … , {N}_{s} - 1 \qquad ( 2 )$$

where cₙ=[c_{1,n} . . . c_{N}_{_{T}}_{,n}]^{T}, aₙ=[a_{1,n} . . . a_{N}_{_{T}}_{,n}]^{T}, and xₙ=[x_{1,n} . . . x_{N}_{_{T}}_{,n}]^{T}.

After transmitter preceding, for each transmit stream, a cyclic prefix (CP), which is the last part of the precoded data block, is inserted in front of that block to remove the inter-block interference (for convenience, the processing related to CP is not depicted in FIG. 3). The frequency selective fading channels between the N_{T} transmit antennas and the N_{R} receive antennas are assumed to be mutually uncorrelated, have a time-invariant impulse response with a memory of L symbols in one block and may be varying in another block transmission period.

As shown in FIG. 3, the signal on the i-th receive antenna, r_{i,n}, after removing the part of CP, can be given by Equation (3):

$${r}_{i , n} = {\sum }_{p = 1}^{{N}_{T}} {\sum }_{m = 0}^{L - 1} {h}_{m , ip} {x}_{p , ( n - m ) mod N} + {v}_{i , n} \\ n = 0 , … , N - 1 \qquad ( 3 )$$

where v_{i,n} is the additive white Gaussian noise (AWGN) from the i-th receive antennas. It is assumed that noise components from different receive antennas have the same variance σᵥ². Likewise, h_{m,ip} is the m-th tap of the impulse response of the channel between the p-th transmit antenna and the i-th receive antenna. By defining rₙ=[r_{1,n} . . . r_{N}_{_{R}}_{,n}]^{T}, vₙ=[v_{1,n} . . . v_{N}_{_{R}}_{,n}]^{T}, and hₘ to be an N_{R}-by-N_{T} matrix with the entry being h_{m,ij}, Equation (3) yields Equation (4):

$${r}_{n} = {\sum }_{m = 0}^{N - 1} {h}_{m} {x}_{( n - m ) mod N} + {v}_{n} \\ n = 0 , … , N - 1. \qquad ( 4 )$$

It is noted that hₘ is a zero matrix for m≧L. If the discrete Fourier transform (DFT) operation is defined as

$${X}_{k} = 1 / \sqrt{N} {\sum }_{n = 0}^{N - 1} {x}_{n} {e}^{- j \frac{2 π}{N} kn}$$

for k=0, . . . , N−1, where xₙ and Xₖ are the time domain sequence and its frequency domain sequence, respectively, then, after applying the DFT operation by DFT components 340, 342 to each element of rₙ in Equation (4), the Equation (5) pertains in the frequency domain:

Rₖ=HₖXₖ+Vₖ k=0, . . . , N−1 (5)

where Hₖ is an N_{R}-by-N_{T} matrix representing the channel frequency response at the k-th tone with the entry

$${H}_{k , pq} = {\sum }_{n = 0}^{N - 1} {h}_{n , pq} {e}^{- j \frac{2 π}{N} kn} .$$

In one example, the above DFT operation can be implemented efficiently by using a fast Fourier transform (FFT) operation.

After equalizing Rₖ in the frequency domain by FDE component 350 and converting the result to the time domain by the inverse discrete Fourier transform (IDFT) operation of IDFT components 360, 362, the equalized data, wₙ, is mapped to the interval (−M,M] with the same modulo operation of modulo components 370, 372 as components 302, 304 found in the precoder 300. The estimate of the original information data, ŝₙ, is then obtained through hard detection, which function can be included in modulo components 370, 372. In one example, the above IDFT operation can be implemented efficiently by using an inverse fast Fourier transform (IFFT) operation.

### THP-FDE MIMO Systems

Optimal designs of the parallel and successive THP-FDE MIMO techniques can be discussed in the MMSE sense. With the parallel THP-FDE technique, previous N_{fb} precoded symbols of all information streams are fed back in the current preceding loop. In the successive THP-FDE technique all of the transmit streams are ordered by some algorithm and then precoded sequentially. Thus, not only N_{fb} previous precoded symbols of all information streams, but also the precoded symbols of lower indexed steams in the current preceding loop can be used for the preceding of higher indexed streams. First, coefficients derivation of the two THP-FDE MIMO techniques is described below, and then the ordering problem in the successive THP-FDE technique is discussed in more detail.

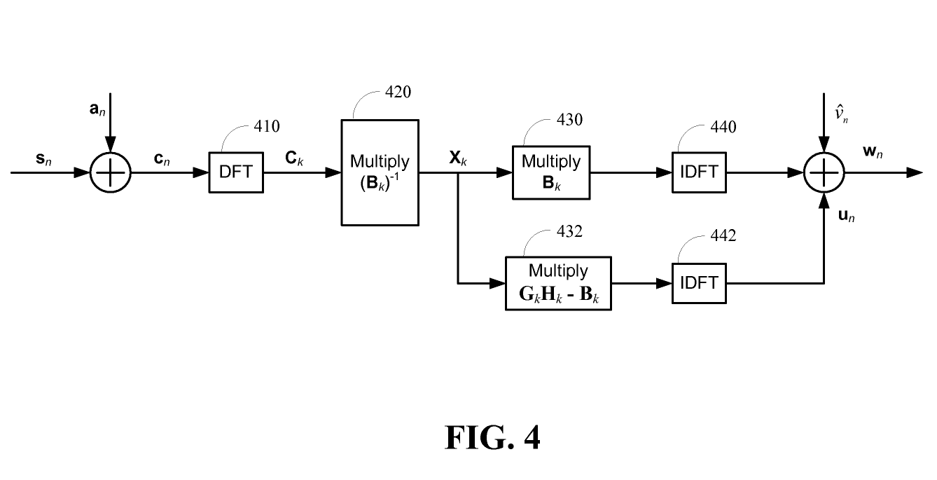

With respect to coefficients derivation, based on MMSE THP TDE design principles, an equivalent system diagram of FIG. 3 is presented in FIG. 4. Based on the equivalent system diagram of FIG. 4, the MSE expression can be obtained as described in more detail below. Then, it is shown that the coefficients of THP and FDE can be obtained by minimizing the MSE.

Considering Equation (2) above, since the length of information symbols in each block is Nₛ, the signals sₙ and aₙ for n=Nₛ, . . . , N−1 can be defined freely. In this respect, these undefined values can be set to satisfy Equation (2) as shown in Equation (6):

$${c}_{n} ≡ {s}_{n} + {a}_{n} = {\sum }_{l = 0}^{{N}_{fb}} {b}_{l} {x}_{( n - l ) mod N} n = 0 , … , N - 1. \qquad ( 6 )$$

It is noted that both the parallel and the successive THP-FDE techniques can be described by using the same system diagram in FIG. 4, though the definitions of b₀ are different for each. For the parallel THP-FDE technique, b₀=I_{N}_{_{T}}. For the successive THP-FDE technique, b₀ is a lower triangular matrix with the diagonal elements being 1. By applying the DFT operation to both sides of Equation (6), Equation (7) is obtained as follows:

Cₖ≡Sₖ+Aₖ=BₖXₖ k=0, . . . , N−1 (7)

where the entry of Bₖ is

$${B}_{k , pq} = {\sum }_{n = 0}^{N - 1} {b}_{n , pq} {e}^{- j \frac{2 π}{N} kn} .$$

In this regard, the left side of FIG. 4 generally represents a block diagram implementation of Equation (7). Signals sₙ and aₙ are summed, and DFT component 410 operates to translate to the frequency domain. Multiply components 420, 430, 432 cooperate to process the signals prior to returning the signal representations to the time domain by IDFT components 440, 442.

FIG. 4 clearly shows that the resulting equalized signal, wₙ, is composed of three parts: (1) the desired symbol which is the signal in the upper branch, (2) the remaining interference, uₙ, which is the signal in the lower branch, and (3) the filtered noise \hat{v}ₙ. The error vector εₙ, which is on the detection of cₙ, is the sum of the remaining interference and the filtered noise as shown in Equation (8):

$${ɛ}_{n} = {u}_{n} + {\hat{v}}_{n} = \frac{1}{\sqrt{N}} {\sum }_{k = 0}^{N - 1} ( {G}_{k} {H}_{k} - {B}_{k} ) {X}_{k} {e}^{j \frac{2 π}{N} kn} + \frac{1}{\sqrt{N}} {\sum }_{k = 0}^{N - 1} {G}_{k} {V}_{k} {e}^{j \frac{2 π}{N} kn} \qquad ( 8 )$$

where Gₖ is the N_{T}-by-N_{R} coefficient matrix of FDE at the k-th frequency tone. By applying the convolution property of DFT to Equation (8) and after some manipulation, the error vector εₙ can be expressed as Equation (9):

$${ɛ}_{n} = \frac{1}{\sqrt{N}} {\sum }_{k = 0}^{N - 1} {G}_{k} {H}_{k} {X}_{k} {e}^{j \frac{2 π}{N} kn} - {\sum }_{l = 0}^{{N}_{fb}} {b}_{l} {x}_{( n - l ) mod N} + \frac{1}{\sqrt{N}} {\sum }_{k = 0}^{N - 1} {G}_{k} {V}_{k} {e}^{j \frac{2 π}{N} kn} . \qquad ( 9 )$$

As a result, the MSE, which is the trace of the autocorrelation matrix of εₙ, is given by Equation (10):

MSE=tr{E{εₙεₙ^{H}}}=tr{E{(uₙ+\hat{v}ₙ)(uₙ+\hat{v}ₙ)^{H}}}. (10)

The optimal coefficients of THP and FDE are thus found by minimizing the MSE. It is noted that the precoded symbols x_{m,n} are independent and identically distributed (i.i.d.) when M is large, regardless of the choice of B(z). Under this condition and by substituting Equation (9) into Equation (10), differentiating Equation (10) with respect to Gₖ, and setting the result to zero, the optimal coefficients for FDE are obtained according to Equation (11):

$${G}_{k} = {σ}_{x}^{2} {\sum }_{l = 0}^{{N}_{fb}} {b}_{l} {e}^{- j \frac{2 π}{N} kl} {H}_{k}^{H} {T}_{k}^{- 1} \qquad ( 11 )$$

where Tₖ=(σᵥ²I_{N}_{_{R}}+σₓ²HₖHₖ^{H}). Then, by substituting Equation (11) into Equation (9) and after some manipulation, the autocorrelation matrix of εₙ is obtained according to Equation (12):

$$E \{ {ɛ}_{n} {ɛ}_{n}^{H} \} = \frac{{σ}_{x}^{2} {σ}_{v}^{2}}{N} {\sum }_{{l}_{1} = 0}^{{N}_{fb}} {\sum }_{{l}_{2} = 0}^{{N}_{fb}} {b}_{{l}_{1}} {\sum }_{k = 0}^{N - 1} {Γ}_{k}^{- 1} {e}^{- j \frac{2 π}{N} k ( {l}_{1} - {l}_{2} )} {b}_{{l}_{2}}^{H} \qquad ( 12 )$$

where Γₖ=(σᵥ²I_{N}_{_{T}}+σₓ²Hₖ^{H}Hₖ). By letting b=[b₀ . . . b_{N}_{_{fb}}] and considering Q defined as:

$$Q = [ \begin{matrix}{q}_{0} & {q}_{1} & ⋯ & {q}_{{N}_{fb}} \\ {q}_{1}^{H} & {q}_{0} & ⋯ & {q}_{{N}_{fb} - 1} \\ ⋮ & ⋮ & ⋰ & ⋮ \\ {q}_{{N}_{fb}}^{H} & {q}_{{N}_{fb} - 1}^{H} & ⋯ & {q}_{0}\end{matrix} ]$$

where

$${q}_{n} = {\sum }_{k = 0}^{N - 1} {Γ}_{k}^{- 1} {e}^{j \frac{2 π}{N} kn} ,$$

Equation (12) can be re-written in a more concise form as Equation (13):

$$E \{ {ɛ}_{n} {ɛ}_{n}^{H} \} = \frac{{σ}_{x}^{2} {σ}_{v}^{2}}{N} {bQb}^{H} . \qquad ( 13 )$$

The optimal coefficients of the precoder can be obtained by solving the following constrained optimization problem represented in Equation (14):

$${min}_{b} tr \{ E \{ {ɛ}_{n} {ɛ}_{n}^{H} \} \} = \frac{{σ}_{x}^{2} {σ}_{v}^{2}}{N} {min}_{b} tr \{ {bQb}^{H} \} \qquad ( 14 )$$

subject to Equation (15):

bΨ=b₀ (15)

where Ψ=[I_{N}_{_{T}} 0_{N}_{_{T}}_{×N}_{_{T}}_{N}_{_{fb}}]^{T}. By applying a Lagrangian optimization method, the optimal b is given by Equation (16):

b=b₀(Ψ^{H}Q⁻¹Ψ)⁻¹Ψ^{H}Q⁻¹. (16)

Taking

$$Q = [ \begin{matrix}{Q}_{11} & {Q}_{12} \\ {Q}_{12}^{H} & {Q}_{22}\end{matrix} ] and {Q}^{- 1} = [ \begin{matrix}{R}_{11} & {R}_{12} \\ {R}_{12}^{H} & {R}_{22}\end{matrix} ] ,$$

where R₁₁ and Q₁₁ are N_{T}-by-N_{T} matrices and R₂₂ and Q₂₂ are N_{T}N_{fb}-by-N_{T}N_{fb} matrices, then Equation (16) can be expressed as Equation (17):

b=┌b₀−b₀Q₁₂Q₂₂⁻¹┐. (17)

By substituting b₀=I_{N}_{_{T}} in Equation (17), the optimal coefficients of the parallel THP are obtained as Equation (18):

b_{Opt,Par}=[I_{N}_{_{T}}−Q₁₂Q₂₂⁻¹]. (18)

For the successive THP-FDE technique, the optimal coefficient b₀ are obtained by substituting Equation (18) into Equation (15) and solving the following constrained optimization problem represented in Equation (19):

$${min}_{b} tr \{ E \{ {ɛ}_{n} {ɛ}_{n}^{H} \} \} = {min}_{{b}_{0}} \frac{{σ}_{x}^{2} {σ}_{v}^{2}}{N} tr \{ {b}_{0} {R}_{11}^{- 1} {b}_{0}^{H} \} \qquad ( 19 )$$

subject to the constraint that b₀ is a lower triangular matrix with the diagonal elements being 1. In this regard, the optimal b₀, which satisfies Equation (19) is L⁻¹, where L is the lower triangular matrix in the Cholesky factorization of R₁₁⁻¹=LDL^{II}. By substituting this result into Equation (17), the coefficients of the successive THP are obtained according to Equation (20):

b_{Opt,Suc}=[L⁻¹−L⁻¹Q₁₂Q₂₂⁻¹]. (20)

In this case, the resulting MMSE can be expressed as Equation (21):

$$tr \{ E \{ {ɛ}_{n} {ɛ}_{n}^{H} \} \} = tr \{ \frac{{σ}_{x}^{2} {σ}_{v}^{2}}{N} D \} = \frac{{σ}_{x}^{2} {σ}_{v}^{2}}{N} {\sum }_{i = 1}^{{N}_{T}} {D}_{ii} . \qquad ( 21 )$$

Finally, after substituting Equation (18) and Equation (20) into Equation (11), the coefficients of FDE in parallel and successive THP-FDE architectures are obtained, respectively. It is noted that when N_{fb} is reduced to zero, the parallel THP-FDE MIMO technique is equivalent to the conventional FD-LE MIMO technique, where the FDE coefficients in Equation (11) can be expressed as Equation (22):

G_{FD-LE,k}=σₓ²Hₖ^{H}Tₖ⁻¹. (22)

It should also be noted that when the number of transmit antennas and receiver antennas is reduced to one, both the parallel and successive THP-FDE MIMO techniques become the THP-FDE SISO technique. In this case, the coefficients of the feed forward FDE can be derived from Equation (11) and expressed as Equation (23):

$${G}_{k} = \frac{{σ}_{x}^{2} {H}_{k}^{*} ( {\sum }_{m = 0}^{{N}_{fb}} {b}_{m} {e}^{- j \frac{2 π}{N} mk} )}{{σ}_{x}^{2} {\vert {H}_{k} \vert}^{2} + {σ}_{v}^{2}} k = 0 , … , N - 1. \qquad ( 23 )$$

From Equation (17) above, the coefficients of the precoder in the SISO case are found to be the solution of the following linear equations of Equation (24):

$${\sum }_{m = 1}^{{N}_{f b}} {\sum }_{k = 0}^{N - 1} {b}_{m} {e}^{j \frac{2 π}{N} k ( n - m )} {Q}_{k} = - {\sum }_{k = 0}^{N - 1} {e}^{j \frac{2 π}{N} k n} {Q}_{k} n = 1 , … , {N}_{f b} \qquad ( 24 )$$

where Qₖ=1/(σₓ²|Hₖ|²+σᵥ²). Finally, by substituting Equation (23) and Equation (24) into Equation (10), the MMSE in the SISO case is obtained as Equation (25):

$$M M S {E}_{S I S O} = \frac{{σ}_{x}^{2} {σ}_{v}^{2}}{ N} {\sum }_{k = 0}^{N - 1} \frac{{\vert {\sum }_{l = 0}^{{N}_{f b}} {b}_{n} {e}^{- j \frac{2 π}{N} l k} \vert}^{2}}{{σ}_{x}^{2} {\vert {H}_{k} \vert}^{2} + {σ}_{v}^{2}} . \qquad ( 25 )$$

A comparison of the coefficients in Equation (23) and Equation (24), and the resulting MMSE in Equation (25) to those of a conventional FD-DFE SISO technique show that they are of the same form. Furthermore, by comparing the parallel THP-FDE MIMO technique with a conventional FD-DFE MIMO technique that include a feed forward FDE and a time domain feedback filter at the receiver, the coefficients and the resulting MMSE of the parallel THP-DFE MIMO technique are found to have the same expressions as those in the conventional FD-DFE MIMO technique. This is because the feedback time domain filter in the receiver of the FD-DFE MIMO technique is moved to the transmit side and replaced by the transmit THP in the parallel THP-FDE MIMO technique. To avoid the large variation of the magnitude of the precoded signals, the modulo operation can be used in THP at the cost of a small increase of the transmit power and a slight increase in error probability for detecting the symbols at the outer constellation boundary. However, for high-order modulations, i.e., for large values of M, where the transmission power penalty can be ignored, the parallel THP-FDE MIMO technique achieves the same performance as the conventional FD-DFE MIMO technique with correct feedback. Based on this fact, the successive THP-FDE technique performs better than FD-DFE MIMO since it cancels more ICIs than the parallel THP-FDE.

Furthermore, the THP-FDE techniques described herein advantageously avoid the error propagation problem of FD-DFE since the feedback processing is performed before transmission. Below, the THP-FDE techniques described herein are shown to demonstrate significant performance gains over the conventional FD-DFE technique with the feedback of the detected symbols.

### Ordering Algorithms for Transmit Streams

In the case of the successive THP-FDE technique, the transmit streams are ordered before the successive preceding following from the fact that different orders result in different system performances. In the following, an ordering algorithm is proposed based on a “best first” approach, though other less optimal ordering approaches are possible. With such an algorithm, the preceding order is found in an iterative way, whereby in each step, the stream that has the minimum MMSE among the remaining streams is selected and precoded. Such algorithm leads to a global optimum order, which minimizes the maximum of MMSEₚ over all possible orders, where MMSEₚ denotes the MMSE value of the p-th transmit stream in an order. In addition, a low-complexity suboptimal MMSE ordering algorithm is introduced.

In the following, it is assumed that each information stream is transmitted on a certain antenna and the correspondence between a stream and its transmit antenna will not be changed for different ordering results. Thus, the optimal order is obtained in an iterative search, where the stream with the minimum MMSE will be selected for each iteration step. After i iterations, i streams are selected and assigned indices. For the (i+1)-th iteration step, the optimal feedback coefficients of the i streams are found, which have been ordered, for the ICI cancellation to the remaining N_{T}−i streams. Then, the resulting MMSEs of these N_{T}−i streams are calculated. After that, the stream which has the minimum MMSE among these N_{T}−i streams is selected and assigned the index number i+1. This process is repeated until all of the N_{T} streams are ordered.

The first step of the ordering algorithm begins with consideration of Equation (20). For convenience, Ω⁽¹⁾ is defined as

$${Ω}^{( 1 )} ≡ \frac{{σ}_{x}^{2} {σ}_{v}^{2}}{N} {R}_{11}^{- 1} ,$$

where the superscript in (.)^{(l)} denotes the l-th iteration step. In this regard, the preceding of the first stream in the successive THP-FDE is the same as that of the parallel THP-FDE, where only previous N_{fb} precoded symbols from all the N_{T} streams are available for feedback.

Thus, in the MMSE sense, the first selected stream is the one that has the minimum MMSE in the parallel THP-FDE, that is, the one with the minimum diagonal element of Ω⁽¹⁾. After identifying this stream, the index of this stream (assuming its original index is i) is exchanged with that of the stream whose index is one. The new channel matrix is then equal to H′ₖ=HₖP⁽¹⁾, where P⁽¹⁾ is a permutation matrix which is used to exchange the i-th column and the first column of Hₖ. By substituting the new channel matrix in Equation (19), Equation (26) is obtained:

$${min}_{b} t r \{ E \{ {ɛ}_{n} {ɛ}_{n}^{H} \} \} = {min}_{{b}_{0}} t r \{ {b}_{0} {P}^{( 1 )} {Ω}^{( 1 )} {P}^{( 1 )} {b}_{0}^{H} \} . \qquad ( 26 )$$

Also defined is T⁽¹⁾≡P⁽¹⁾Ω⁽¹⁾P⁽¹⁾ and dividing it into blocks yields

$$[ \begin{matrix}{T}_{11}^{( 1 )} & {T}_{12}^{( 1 )} \\ {( {T}_{12}^{( 1 )} )}^{H} & {T}_{22}^{( 1 )}\end{matrix} ] ,$$

where T₁₁⁽¹⁾ is a 1-by-1 matrix and also the MMSE of the selected stream. The next objective is to find the optimal feedback coefficients of this stream for ICI cancellation of the remaining streams. Thus, a vector s⁽¹⁾=[s₂⁽¹⁾ . . . s_{N}_{_{T}}⁽¹⁾]^{T} is defined containing these coefficients. By further defining Equation (27) as follows:

$${S}^{( 1 )} = [ \begin{matrix}1 & {0}_{1 \times {N}_{T} - 1} \\ {S}^{( 1 )} & {I}_{{N}_{T} - 1}\end{matrix} ] \qquad ( 27 )$$

and replacing b₀ in Equation (19) with S⁽¹⁾, the autocorrelation matrix of the error vector is obtained as follows.

$${S}^{( 1 )} {{T}^{( 1 )} ( {S}^{( 1 )} )}^{H} = [ \begin{matrix}{T}_{11}^{( 1 )} & {{T}_{11}^{( 1 )} ( {s}^{( 1 )} )}^{H} + {T}_{12}^{( 1 )} \\ {s}^{( 1 )} {T}_{11}^{( 1 )} + {( {T}_{12}^{( 1 )} )}^{H} & Λ\end{matrix} ] \qquad ( 28 )$$

where

Λ≡s⁽¹⁾T₁₁⁽¹⁾(s⁽¹⁾)^{H}+s⁽¹⁾T₁₂⁽¹⁾+(s⁽¹⁾T₁₂⁽¹⁾)^{H}+T₂₂⁽¹⁾. (29)

In this regard, the optimal s⁽¹⁾ that minimizes the MSE of the remaining streams is the one that minimizes the trace of the right-bottom block matrix in Equation (29). By differentiating the trace of that block matrix with respect to s⁽¹⁾ and setting the result to zero, we have s⁽¹⁾=−(T₁₂⁽¹⁾)^{H}(T₁₁⁽¹⁾)⁻¹. By substituting this result into Equation (29), Equation (30) is obtained as follows:

$${S}^{( 1 )} {{T}^{( 1 )} ( {S}^{( 1 )} )}^{H} = [ \begin{matrix}{T}_{11}^{( 1 )} & 0 \\ 0 & {T}_{22}^{( 1 )} - {( {T}_{12}^{( 1 )} )}^{H} {( {T}_{11}^{( 1 )} )}^{- 1} {T}_{12}^{( 1 )}\end{matrix} ] . \qquad ( 30 )$$

This completes the first iteration step. The second iteration step is then started by defining Ω⁽²⁾≡T₂₂⁽¹⁾−(T₁₂⁽¹⁾)^{H}(T₁₁⁽¹⁾)⁻¹T₁₂⁽¹⁾ and repeating the same operations as those in the first step.

The optimal MMSE ordering algorithm for the successive THP-FDE MIMO technique is represented in pseudo-flow as follows.

Initialization:

$$i ← 1$$

$${Ω}^{( 1 )} = \frac{{σ}_{x}^{2} {σ}_{v}^{2}}{N} ( {Q}_{11} - {Q}_{12} {Q}_{22}^{- 1} {Q}_{12}^{H} )$$

Recursion:

kᵢ=argmin_{kε[1(N}_{_{T}}_{-i+1)]}{Ωₖₖ⁽ⁱ⁾} 1.

Find P⁽ⁱ⁾ according to kᵢ 2.

T⁽ⁱ⁾=P⁽ⁱ⁾Ω⁽ⁱ⁾P⁽ⁱ⁾ 3.

s⁽ⁱ⁾=−(T₁₂⁽ⁱ⁾)^{H}(T₁₁⁽ⁱ⁾)⁻¹ 4.

Ω⁽ⁱ⁺¹⁾=T₂₂⁽ⁱ⁾−(T₁₂⁽ⁱ⁾)^{H}(T₁₁⁽ⁱ⁾)⁻¹T₁₂⁽ⁱ⁾ 5.

i←i+1 6.

It should be noted that when the last iteration step is completed, the optimal coefficient matrix b₀ can be calculated by combining the coefficients generated in each iteration step. Let s_{f}⁽ⁱ⁾ and S_{f}⁽ⁱ⁾ denote the modified vector of s⁽ⁱ⁾ and the modified matrix of S⁽ⁱ⁾ by changing their elements order according to the final sequence. The optimal coefficient matrix b₀ can be given by Equation (31):

$${b}_{0} = {\prod }_{i = 1}^{{N}_{T}} [ \begin{matrix}{I}_{{N}_{T} - i} & {0}_{( {N}_{T} - i ) \times i} \\ {0}_{i \times ( {N}_{T} - i )} & {S}_{f}^{( {N}_{T} - i + 1 )}\end{matrix} ] . \qquad ( 31 )$$

The MMSE ordering algorithm is based on the consideration that the worst stream dominates the error performance of the system and its effect on the whole system should be minimized. However, in contrast to conventional systems, where the minimum of post-detection SNRs is used as the figure of merit for the vertical Bell labs layered space-time (V-BLAST) system, in the successive THP-FDE system, the maximum MMSE is considered. For completeness, a proof of the optimality of the ordering algorithm in the sense of minimizing the maximum of MMSEs is given below, however, such description should be considered a non-limiting learning aid. It should be noted here that it is difficult to prove whether the ordering algorithm is optimal in the bit error rate (BER) sense because it is difficult to find a direct relationship between MMSE and BER. However, as it is shown below, and by using a BER approximation, it is also shown that equalized signals with smaller MMSE also have better BER performance. Thus, the ordering algorithm, which tries to minimize the maximum of MMSEs, similarly implies an improvement in the BER sense.

The above described optimal MMSE ordering algorithm requires extra operations to calculate and compare the MMSEs in each iteration step. To help avoid the expense of the optimal MMSE ordering algorithm, a suboptimal MMSE ordering algorithm can optionally be applied that orders all streams only according to their MMSEs when no transmit precoding is performed. These MMSE values are the diagonal elements of the autocorrelation matrix of the error vector in (12) when N_{fb}=0. That is,

$$E \{ {ɛ}_{n} {ɛ}_{n}^{H} \} = \frac{{σ}_{x}^{2} {σ}_{v}^{2}}{N} {\sum }_{k = 0}^{N - 1} {Γ}_{k}^{- 1} . \qquad ( 32 )$$

In this respect, the suboptimal ordering algorithm has much lower computational complexity. Numerical results presented below show that the above suboptimal MMSE ordering algorithm can perform as well as the optimal one.

With respect to the system structure and the coefficients derivation, as discussed above, the optimal design of the parallel THP-FDE MIMO technique in the MMSE sense has the same coefficients and MMSE expressions as those in the conventional FD-DFE MIMO technique. The error probability of FD-DFE MIMO can be related to the MMSE using a modified Chernoff bound (MCB). These performance analysis results can also apply to the THP-FDE MIMO techniques. It is noted that the MCB was previously derived under the condition that the transmitted QAM symbols are i.i.d., while in the THP-FDE MIMO techniques the signals to be transmitted are the precoded symbols and are approximately i.i.d. when M is large. It is also noted that because of the modulo processing, there will be a slight increase in error probability for detecting the symbols at the outer constellation boundary. As a result, herein, the following theoretical result is referred to as the modified Chernoff approximation (MCA). In this regard, the MCA of the parallel and successive THP-FDE MIMO techniques can be shown to be given by Equation (33):

$$B E {R}_{M I M O} \approx \frac{1}{{N}_{T}} {\sum }_{p = 1}^{{N}_{T}} \frac{M - 1}{M {log}_{2} M} \frac{M M S {E}_{p}}{\sqrt{π} {σ}_{\hat{v} , p}} exp \{ \frac{1}{{σ}_{x}^{2}} - \frac{1}{M M S {E}_{p}} \} \qquad ( 33 )$$

where σₓ²=2M²/3, σ_{\hat{v},p}² is the p-th diagonal element of the matrix

$${σ}_{v}^{2} / N {\sum }_{k = 0}^{N - 1} {G}_{k} {G}_{k}^{H} ,$$

with Gₖ given by Equation (11), and MMSEₚ is the p-th diagonal element of E{εε^{H}}.

One can observe from Equation (33) that the value in the exponential function dominates the MCA calculation. In this regard, MMSEₚ is less than σₓ². Since MMSE is always larger than zero, systems that have larger MMSE will have a larger error probability. It is also noted that by varying the parameters in the result, MCA will be applicable to SISO, MISO, and SIMO systems employing THP-FDE. Numerical results presented below show that the MCA is very close to the true simulated results and can be considered as an excellent tool for system analysis and evaluation.

With respect to channel state information (CSI) mismatch, one issue for practical implementations of THP-FDE is that the transmitter should have a precise knowledge of CSI. However, CSI mismatch always exists in real wireless systems due to channel estimation errors and channel variations.

In non-limiting embodiments, the receiver thus estimates the channel through the use of training sequences. The frequency selective channel is assumed to have L independent paths and each path is modeled as a complex Gaussian process. Let h_{l,ij}(n) denote the true channel value of the l-th path between the i-th receive antenna and j-th transmit antenna at time n, with variance σₕ_{_{l,ij}}²=E{|h_{l,ij}(n)|²}, which is determined by the channel power-delay profile and can be normalized by setting

$${\sum }_{l = 0}^{L - 1} {σ}_{{h}_{l , i j}}^{2} = 1.$$

Furthermore, it is also assumed that each path has the same normalized power spectral density (PSD) per Equation (34):

$$\frac{{p}_{l} ( f )}{{p}_{l} ( 0 )} = \frac{1}{\sqrt{1 - {( f / {f}_{d} )}^{2}}} \qquad ( 34 )$$

where f_{d}=vf_{c}/c is the maximum Doppler frequency with v, f_{c}, and c being the vehicle speed, the carrier frequency, and the speed of light, respectively.

For a particular path l, let ĥ_{l,ij}(n) denote the estimate of h_{l,ij}(n). Without taking a special channel estimation method into account, a statistical model can be used to represent the true channel and its estimates, which is

ĥ_{l,ij}(n)=ρ_{l,ij}(h_{l,ij}(n)+ζ_{l,ij}(n)) l=0, . . . , L−1 (35)

where ζ_{l,ij}(n) is the channel estimation error with the variance σ_{ζ}_{_{l,ij}}² and is uncorrelated with ĥ_{l,ij}(n). Likewise, ρ_{l,ij} is the correlation coefficients between ĥ_{l,ij}(n) and h_{l,ij}(n). If ρ_{l,ij} is set equal to {square root over (σₕ_{_{l,ij}}²/(σₕ_{_{l,ij}}²+σ_{ζ}_{_{l,ij}}²))}, the variance of ĥ_{l,ij}(n) will be equal to that of the true channel. The normalized MSE of the channel estimation is then defined according to Equation (36):

$${η}_{l , i j} = \frac{E \{ {\vert {h}_{l , i j} ( n ) - {\hat{h}}_{l , i j} ( n ) \vert}^{2} \}}{E \{ {\vert {h}_{l , i j} ( n ) \vert}^{2} \}} . \qquad ( 36 )$$

It can be shown that the normalized MSE is related to the correlation coefficient as η_{l,ij}=2(1−ρ_{l,ij}).

If the receiver feeds back the estimated CSI to the transmitter directly, the channel variation during the CSI feedback delay can further cause an imperfect transmitter CSI. Intuitively, this effect can be reduced by predicting the future channel values based on a number of previous estimated channel values. Since different paths are mutually uncorrelated, the channel value of each path can be predicted separately. In the following, the prediction of a particular path l is assumed and it is also assumed that the channel delay profile does not change during the prediction window. For convenience, the subscript (.)_{l,ij} is omitted in the channel variable. By defining a p-order linear finite impulse response (FIR) predictor, Equation (37) pertains:

$$\tilde{h} ( n ) = - {\sum }_{i = 1}^{p} {α}_{i}^{p} \hat{h} ( n - i ) \qquad ( 37 )$$

where \tilde{h}(n) is the predicted channel value based on p past estimated channel values, and αᵢ^{p} for i=1, . . . , p is the coefficient of the linear prediction filter. By using a correlation method of auto-regressive (AR) modeling, the optimal parameters of θₚ≡−[αₚ^{p} . . . α₁^{p}]^{T} in the LS sense are obtained according to Equation (38):

θ_{cpt,p}=(Y^{H}Y)⁻¹Y^{H}yₚ (38)

where

$$Y = [ \begin{matrix}\hat{h} ( {N}_{w} - 1 - p ) & … & \hat{h} ( {N}_{w} - 2 ) \\ ⋮ & ⋰ & ⋮ \\ \hat{h} ( 0 ) & … & \hat{h} ( p - 1 )\end{matrix} ]$$

and yₚ=[ĥ(N_{W}−1) . . . ĥ(p)]^{T}, where N_{W} is the size of the prediction sliding window.

After using the same method to predict the channel values between the N_{T} transmitter antennas and the N_{R} receiver antennas, the receiver will feed back the predicted CSI to the transmitter for precoding. It is noted that the CSI at the transmitter is different from that at the receiver, which is obtained based of the estimation of the true channel. To compensate for the CSI mismatch between the transmitter and the receiver, by taking into account that the receiver knows the transmitter CSI, the detection error in Equation (9) in this case can be given by Equation (39):

$${ɛ}_{n} = \frac{1}{\sqrt{N}} {\sum }_{k = 0}^{N - 1} {G}_{k} {H}_{k} {X}_{k} {e}^{j \frac{2 π}{N} k n} - {\sum }_{l = 0}^{{N}_{f b}} {\tilde{b}}_{l} {x}_{( n - l ) mod N} + \frac{1}{\sqrt{N}} {\sum }_{k = 0}^{N - 1} {G}_{k} {V}_{k} {e}^{j \frac{2 π}{N} k n} . \qquad ( 39 )$$

where \tilde{b}ₗ are the coefficients of THP calculated by substituting the transmitter CSI \tilde{h}ₙ into Equation (17). Following the derivation from Equation (9) to Equation (11), the optimal coefficients of FDE in the MMSE sense, provided that the receiver perfectly estimates the channel, are given by Equation (40):

$${G}_{k} = {σ}_{x}^{2} {\sum }_{l = 0}^{{N}_{f b}} {\tilde{b}}_{l} {e}^{- j \frac{2 π}{N} k l} {H}_{k}^{H} {T}_{k}^{- 1} . \qquad ( 40 )$$

In practical systems, the coefficients of FDE can be calculated in Equation (41) by replacing Hₖ with Ĥₖ, which is the estimated channel value. That is,

$${G}_{k} = {σ}_{x}^{2} {\sum }_{l = 0}^{{N}_{f b}} {\tilde{b}}_{l} {e}^{- j \frac{2 π}{N} k l} {{\hat{H}}_{k}^{H} ( {σ}_{x}^{2} {\hat{H}}_{k} {\hat{H}}_{k}^{H} + {σ}_{v}^{2} {I}_{{N}_{R}} )}^{- 1} . \qquad ( 41 )$$

As presented in more detail below, when combined with the AR-model prediction and THP compensation techniques, the THP-FDE techniques are much less sensitive to the channel variation effect.

### Performance Evaluations

First, some sample simulation results are presented to compare the THP-FDE SISO technique with the conventional FD-LE and FD-DFE techniques, along with the MCA. Next, the effects of channel estimation errors and channel variations to the technique are evaluated. Then, the performance of channel prediction and THP compensation techniques is shown.

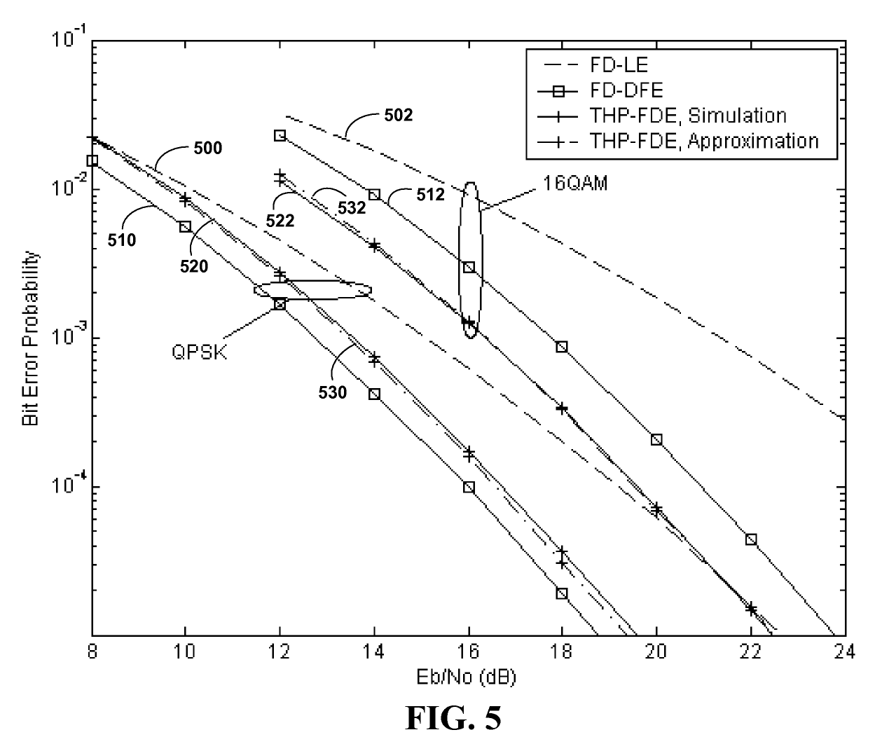

In one non-limiting implementation, each data block is assumed to include 64 symbols. The frequency selective channel is assumed to be a 4-ray equal gain delay profile uncorrelated Rayleigh fading channel with the time delay between the closest rays being one symbol. In the following, N_{fb}=3. FIG. 5 provides the BER performance comparison for the THP-FDE technique with the conventional FD-LE and FD-DFE techniques in a SISO system as a function of E_{b}/N₀ with Quadrature Phase Shift Keying (QPSK) and 16QAM modulations along with the MCA. The FD-LE and FD-DFE curves for QPSK modulation are represented by curves 500 and 510, respectively. The FD-LE and FD-DFE curves for 16QAM modulation are represented by curves 502 and 512, respectively. For comparison, the THP-FDE simulation and approximation curves for QPSK modulation are represented by curves 520 and 530, respectively. The THP-FDE simulation and approximation curves for QPSK modulation are represented by curves 522 and 532, respectively.

It is assumed that both the transmitter and the receiver have perfect CSI knowledge. The curves 500, 502 of FD-LE are the performance of conventional MMSE FD-LE systems, which are equivalent to that of the THP-FDE technique when N_{fb}=0. The curves of FD-DFE 510, 512 are the performance of conventional FD-DFE systems with the feedback of detected symbols. However, it is assumed that the first N_{fb} feedback symbols in each block are correct.

In this regard, FIG. 5 shows that both THP-FDE and FD-DFE achieve better performance than FD-LE. The THP-FDE technique performs slightly worse than the conventional FD-DFE technique in QPSK since it suffers from a high power penalty (about 1.25 dB) for the transmission of precoded symbols. However, in the case of 16QAM, such power penalty (about 0.28 dB) is smaller. Furthermore, as the error propagation in FD-DFE becomes more significant in higher order modulations, the THP-FDE technique performs better than FD-DFE. For example, more than 1 dB performance improvement can be achieved at BER 10⁻⁵. FIG. 5 also shows that the MCA is very close to the Monte Carlo simulation curves proving its suitability as an alternative for evaluation and analysis of the systems.

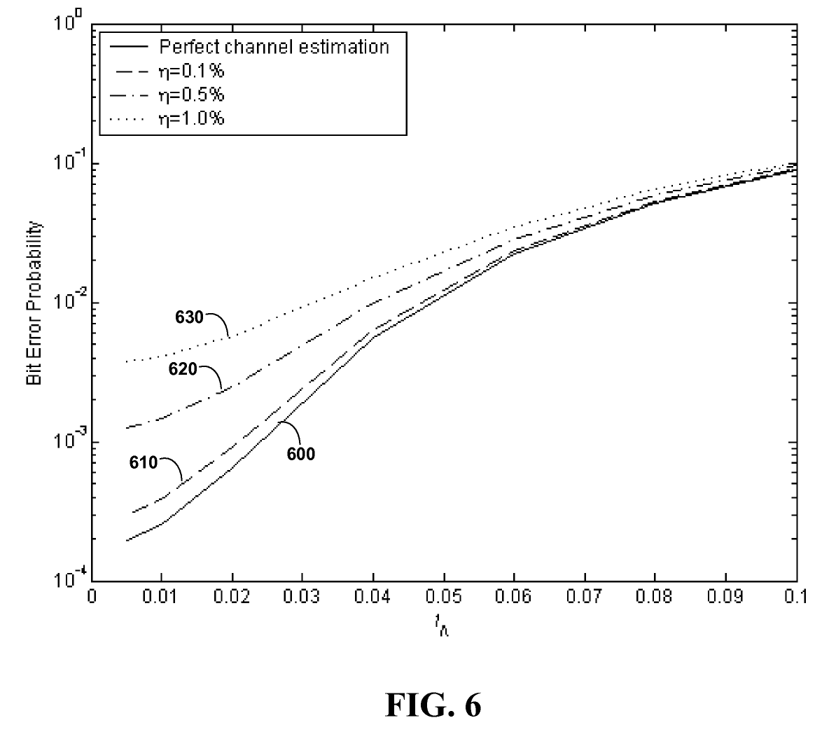

FIG. 6 generally illustrates BER versus normalized Doppler frequency for different normalized channel estimation MSEs in the THP-FDE SISO system with QPSK modulation when E_{b}/N₀=16 dB. In this regard, FIG. 6 shows the channel estimation error and channel variation effects to the THP-FDE technique, where QPSK modulation is considered. It is assumed that the system is operating in a time division duplex (TDD) mode with the frame duration T_{f}=10 ms (the first 5 ms for the uplink transmission and the other 5 ms for the downlink transmission), which is consistent with that in IEEE 802.16a. Since this standard is designed for fixed broadband wireless access systems, a Doppler frequency f_{d} in the range of 0-10 Hz is considered. The baseband time-varying channel value of each path can be generated by passing a complex Gaussian random-process signal through a Doppler filter.

FIG. 6 thus presents the BER performance as a function of the normalized Doppler frequency (i.e., f_{N}=f_{d}×T_{f}) for different normalized MSEs (i.e., η) of channel estimation when E_{b}/N₀ is set at 16 dB. Curve 600 represents conditions of perfect channel estimation, curve 610 represents conditions where η=0.1%, curve 620 represents conditions where η=0.5% and curve 630 represents conditions where η=1%.

The coefficients of THP are calculated from the feedback CSI, which is the estimate of the channel in last TDD frame. At the receiver, the coefficients of FDE are generated from the estimate in the current TDD frame. Thus, in the worst case scenario, the transmitter CSI is 10 ms outdated. In this regard, FIG. 6 demonstrates that the THP-FDE techniques are fairly sensitive to channel estimation errors and channel variations.

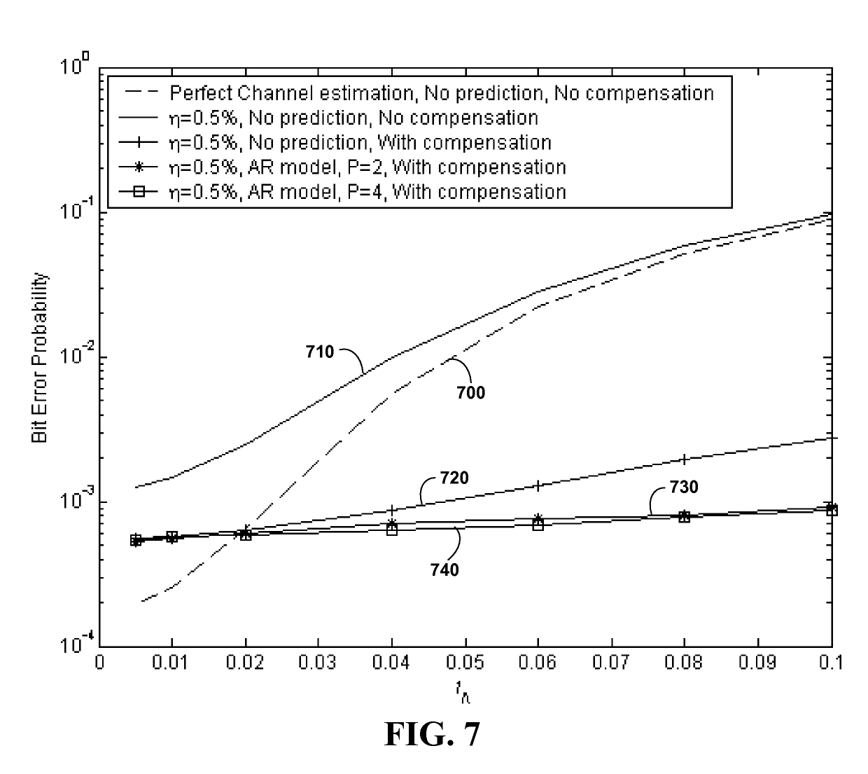

FIG. 7 generally illustrates BER performance results of the AR-model channel prediction and the THP compensation for a THP-FDE SISO system with QPSK modulation when E_{b}/N₀=16 dB. In this regard, FIG. 7 illustrates the system performance when the channel prediction and the THP compensation techniques are applied. A prediction window size N_{W}=20, a normalized MSE of channel estimation of η=0.5%, and prediction orders p=2 and p=4 are considered.

More particularly, curve 700 represents conditions where perfect channel estimation is assumed, and where prediction and compensation are not performed. Curve 710 represents conditions where η=0.5%, and no prediction or compensation are performed. Curve 720 represents conditions where η=0.5%, compensation is performed, but no prediction is performed. Curve 730 represents conditions where η=0.5%, prediction is performed with an autoregressive model with p=2 and where compensation is performed. Curve 730 represents conditions where η=0.5%, prediction is performed with an autoregressive model with p=4 and where compensation is performed.

FIG. 7 thus generally shows that THP compensation can improve the performance along the whole range of f_{N}. This is because, even when the channel is fixed, the transmitter CSI and the receiver CSI are from two independent channel estimates of the same channel and are still mismatched. Furthermore, FIG. 7 shows when channel prediction is also used, the THP-FDE technique is almost insensitive to channel variation.

Some sample simulation results have been described to compare the parallel and successive THP-FDE MIMO techniques with the conventional FD-LE and FD-DFE MIMO techniques, along with the MCA. Additionally, below some numerical results of the successive THP-FDE MIMO technique with different ordering algorithms are provided. Finally, the effect on performance of channel prediction and THP compensation techniques to reduce the channel errors and channel variation effects is demonstrated.

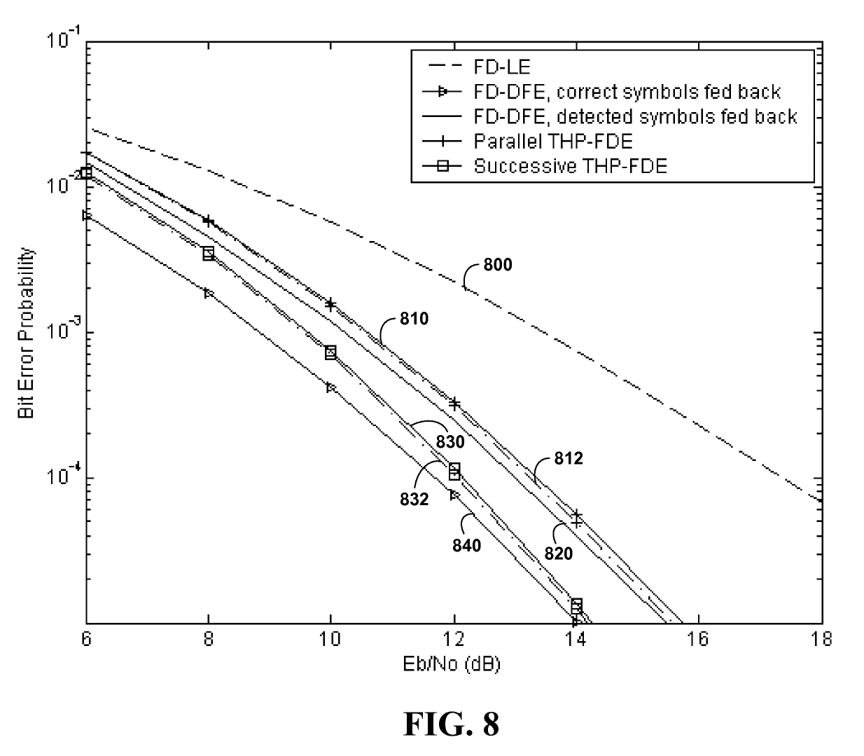

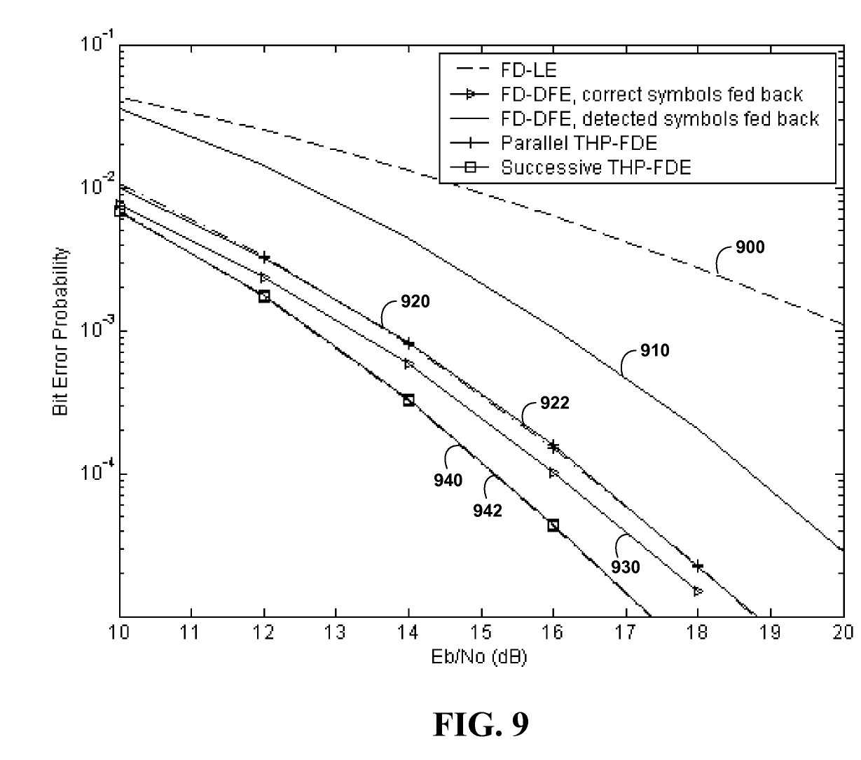

FIG. 8 generally illustrates a BER performance comparison for the parallel and successive THP-FDE techniques with the conventional FD-LE and FD-DFE techniques in a 2-by-2 MIMO system with QPSK modulation. The dash-dot lines represent the results of MCA. FIG. 9 generally illustrates a BER performance comparison for the parallel and successive THP-FDE techniques with the conventional FD-LE and FD-DFE techniques in a 2-by-2 MIMO system with 16QAM modulation. Again, the dash-dot lines represent the results of MCA.

It is noted that the channel model and the data block length in the simulation of MIMO systems are the same as those in the SISO case. In this regard, FIGS. 8 and 9 provide the BER performance as a function of E_{b}/N₀ for several different FDE MIMO techniques in a 2-by-2 MIMO system with QPSK and 16QAM modulations, respectively. It is assumed that both the transmitter and the receiver have perfect CSI. The curve of FD-LE is the performance of conventional FD-LE MIMO techniques. For conventional FD-DFE techniques, two performance curves are shown, one that corresponds to the performance with detected symbols fed back with correct initialization and the other corresponds to the case where correct symbols are always fed back. In the successive THP-FDE technique, the optimal MMSE ordering algorithm is used. Curve 800 represents the FD-LE technique, curve 840 represents the FD-DFE technique with correct symbols fed back, curve 820 represents the FD-DFE technique with detected symbols fed back. For comparison, the parallel THP-FDE simulation and approximation curves for QPSK modulation are represented by curves 810 and 812, respectively. The successive THP-FDE simulation and approximation curves for QPSK modulation are represented by curves 830 and 832, respectively. Thus, FIG. 8 shows that for QPSK the parallel THP-FDE technique performs slightly worse than the conventional FD-DFE technique with detected symbols fed back while the successive THP-FDE technique performs around 1 dB better than FD-DFE.

However, as shown in FIG. 9, for 16QAM, remarkable performance improvement can be achieved in the two techniques. Curve 900 represents the FD-LE technique, curve 930 represents the FD-DFE technique with correct symbols fed back, curve 910 represents the FD-DFE technique with detected symbols fed back. For comparison, the parallel THP-FDE simulation and approximation curves for 16QAM modulation are represented by curves 920 and 922, respectively. The successive THP-FDE simulation and approximation curves for 16QAM modulation are represented by curves 940 and 942, respectively. As illustrated by FIG. 9, more than 2 dB and 3 dB performance improvement over FD-DFE with detected symbols fed back can be achieved at BER 10⁻⁴ for the parallel and successive THP-FDE techniques, respectively. FIGS. 8 and 9 point out that the SNR gap between the parallel THP-FDE technique and the FD-DFE technique with correct symbols fed back is mainly due to the additional transmit power brought by THP. FIGS. 8 and 9 also show that the MCA is also quite close to the Monte Carlo simulation curves in the MIMO case.

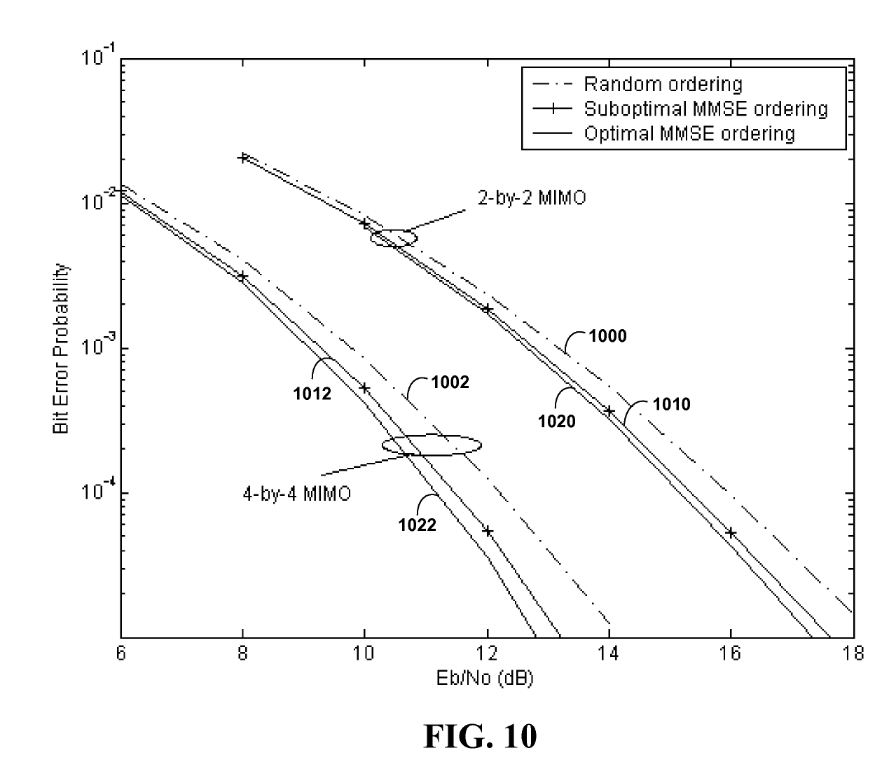

FIG. 10 generally shows BER MCA results of the successive THP-FDE technique with different ordering algorithms for different MIMO systems, e.g., 2 by 2 MIMO systems and 4 by 4 MIMO systems. The MCA is used to investigate the system performance of the successive THP-FDE MIMO technique with three ordering algorithms, which are the random ordering algorithm, the optimal MMSE ordering algorithm and the suboptimal MMSE ordering algorithm, respectively. Two MIMO systems, a 2-by-2 MIMO system and a 4-by-4 MIMO system, are considered with 16QAM modulation. The results for the 2 by 2 MIMO system are represented by curves 1000, 1010 and 1020 for the random ordering, suboptimal MMSE ordering and optimal MMSE ordering, respectively. The results for the 4 by 4 MIMO system are represented by curves 1002, 1012 and 1022 for the random ordering, suboptimal MMSE ordering and optimal MMSE ordering, respectively.

FIG. 10 shows that both the suboptimal and the optimal MMSE ordering algorithms perform better than the random ordering algorithm and such improvement becomes larger as the number of transmit antennas increases. FIG. 10 also shows that the performance of the suboptimal algorithm is very close to the optimal one. Since it has a lower computational complexity, the suboptimal algorithm can be considered for practical applications.

Finally, the system performance of the parallel and successive THP-FDE techniques, respectively, was considered when the channel prediction and the THP compensation techniques are applied to reduce the channel estimation errors and channel variation effects. As was the case of the SISO system, it was found that the channel prediction and THP compensation techniques can also perform very well in THP-FDE MIMO systems. Since FIG. 8 and FIG. 9 show that the THP-FDE MIMO techniques achieve better performance than the conventional FDE MIMO techniques, THP-FDE can be considered as a practical and more attractive FDE structure for future broadband wireless systems.

Recently, it has been shown that SC-FDE can be combined with a MIMO architecture to obtain spatial diversity, achieve high system capacity, or perform SDMA over frequency selective channels. The conventional FD-DFE and FDE-NP techniques can achieve better performance than FD-LE for severely distorted MIMO channels. One problem with FD-DFE and FDE-NP, however, is that any decision errors at the output of the slicer will cause incorrect feedback symbols and further decision errors. Herein, parallel and successive THP-FDE MIMO techniques have been described, where error propagation problems can be avoided by using transmit preceding.

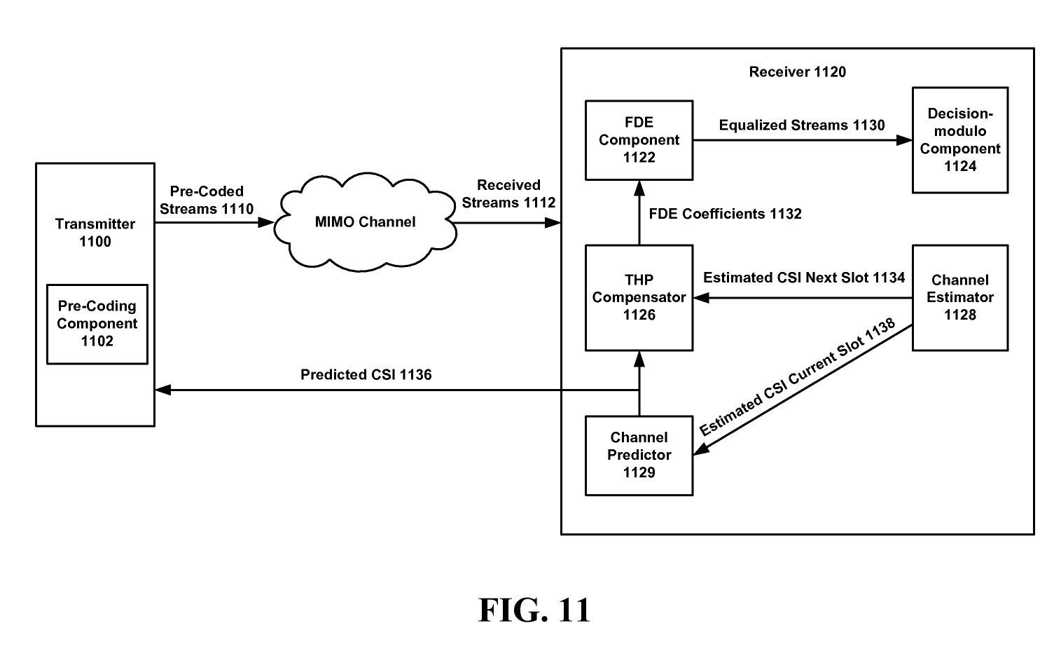

An embodiment of a parallel THP-FDE MIMO system is generally illustrated in the system diagram of FIG. 11 including a transmitter 1100, which may be included in a variety of devices or apparatus, which includes a pre-coding component 1102 for pre-coding the information data streams prior to transmitting the precoded data streams 1110 to a receiver 1120. The received data streams 1112 are equalized at a FDE component 1122, and the resulting equalized streams 1130 are passed through a decision-and-modulo component where the original data streams are retrieved. The pre-coding component 1102 and the FDE component 1122 are jointly optimized based on the MMSE criterion and partial knowledge of the true CSI. In one embodiment, to achieve this, first, a channel estimator 1128 at the receiver estimates the true CSI of the current transmission time slot as shown by estimated CSI 1138. The estimated CSI 1138 is sent to a channel predictor 1129, which predicts the CSI of the next time slot based on the estimated CSI in the current time slot 1138 as well as estimated CSI values from previous time slots. The predicted CSI 1136 is sent to the transmitter 1100 through a feedback channel. Both the predicted CSI 1136 for the next time slot and the estimated CSI in the next time slot 1134 are sent to a THP component to generate the FDE coefficients 1132 of FDE component(s) 1122 according to Equation (41) and Equation (18).

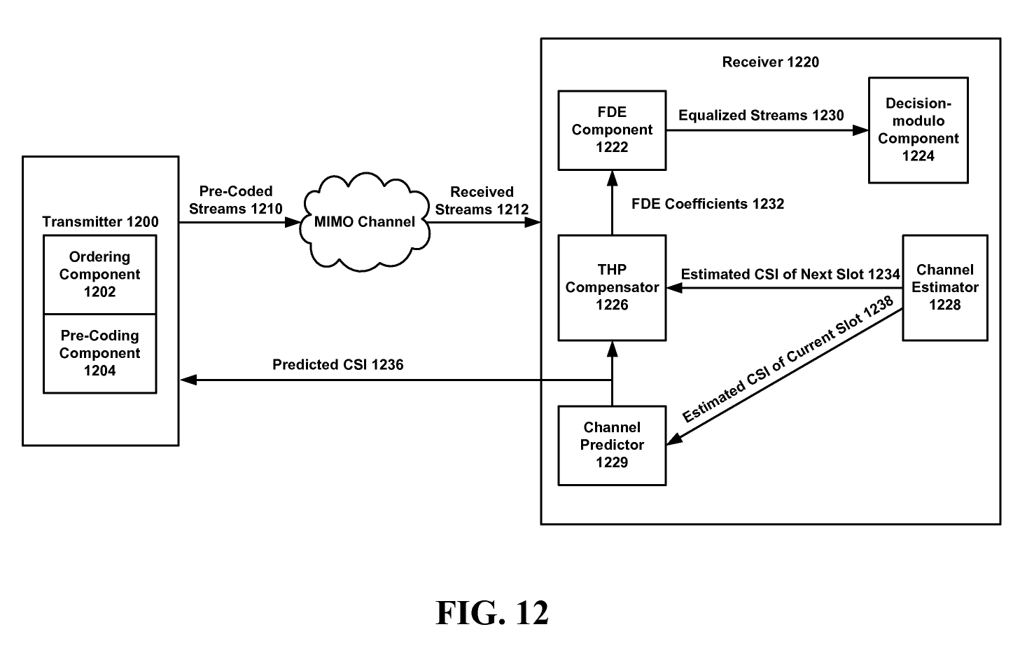

An embodiment of a successive THP-FDE MIMO system is generally illustrated in the system diagram of FIG. 12 including a transmitter 1200, which may be included in a variety of devices or apparatus, which includes an ordering component 1202 for ordering the data streams according to an optimal or suboptimal MMSE ordering algorithm discussed above and also includes a pre-coding component 1204 for pre-coding the information data streams prior to transmitting the precoded data streams 1210 to a receiver 1220. The received data streams 1212 are equalized at a FDE component 1222, and the resulting equalized streams 1230 are passed through a decision-and-modulo component 1224 where the original data streams are retrieved. The pre-coding component 1202 and the FDE component 1222 are jointly optimized based on the MMSE criterion and partial knowledge of the true CSI. First, a channel estimator 1228 at the receiver 1220 estimates the true CSI of current transmission time slot as shown by estimated CSI 1238. The estimated CSI 1238 is sent to a channel predictor 1229, which predicts the CSI of the next time slot based on the estimated CSI in current time slot 1238 as well as estimated CSI values of previous time slots. The predicted CSI 1236 is sent to the transmitter 1200 through a feedback channel. Both the predicted CSI for the next time slot 1236 and the estimated CSI in the next time slot 1234 are sent to a THP component to generate the FDE coefficients 1232 of FDE component(s) 1222 according to Equation (41) and Equation (20).

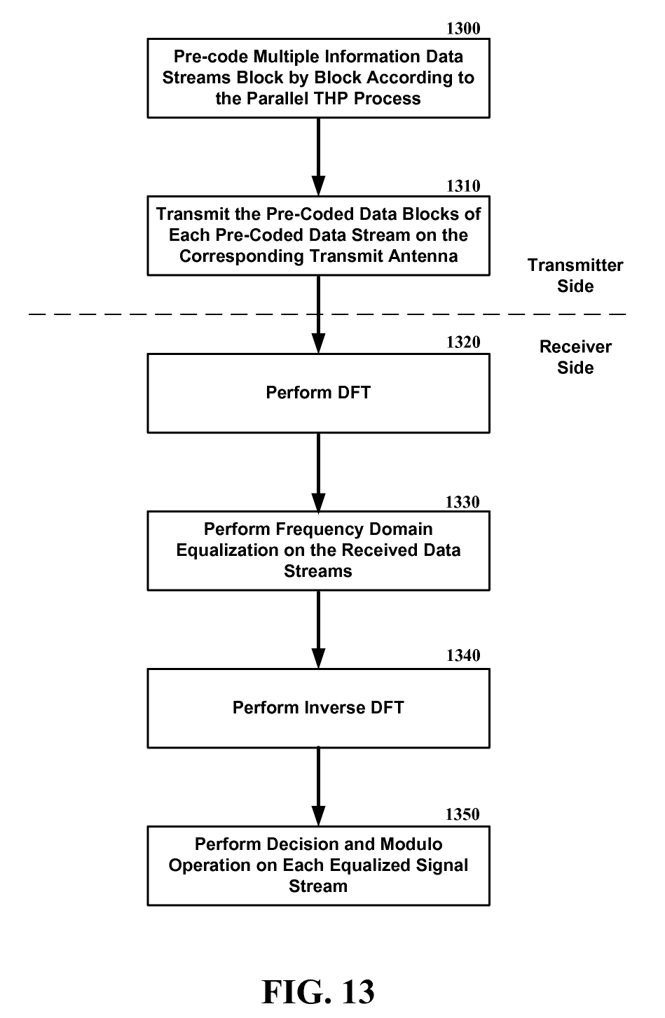

FIG. 13 further illustrates a general flow diagram for a parallel THP-FDE MIMO system, where on the transmitter side, the information data streams are pre-coded at 1300 block by block according to the parallel THP process described above. At 1310, the pre-coded blocks of each precoded data stream are transmitted to the receiver on a corresponding transmit antenna. Then, on the receiver side, among other things, at 1320, a DFT is taken on the received data streams to ready the streams for equalization at 1330. At 1340, the inverse DFT can then be performed on the data streams. Finally, the equalized data streams are passed through 1350 for performing the decision and modulo operation to retrieve the original information data streams.

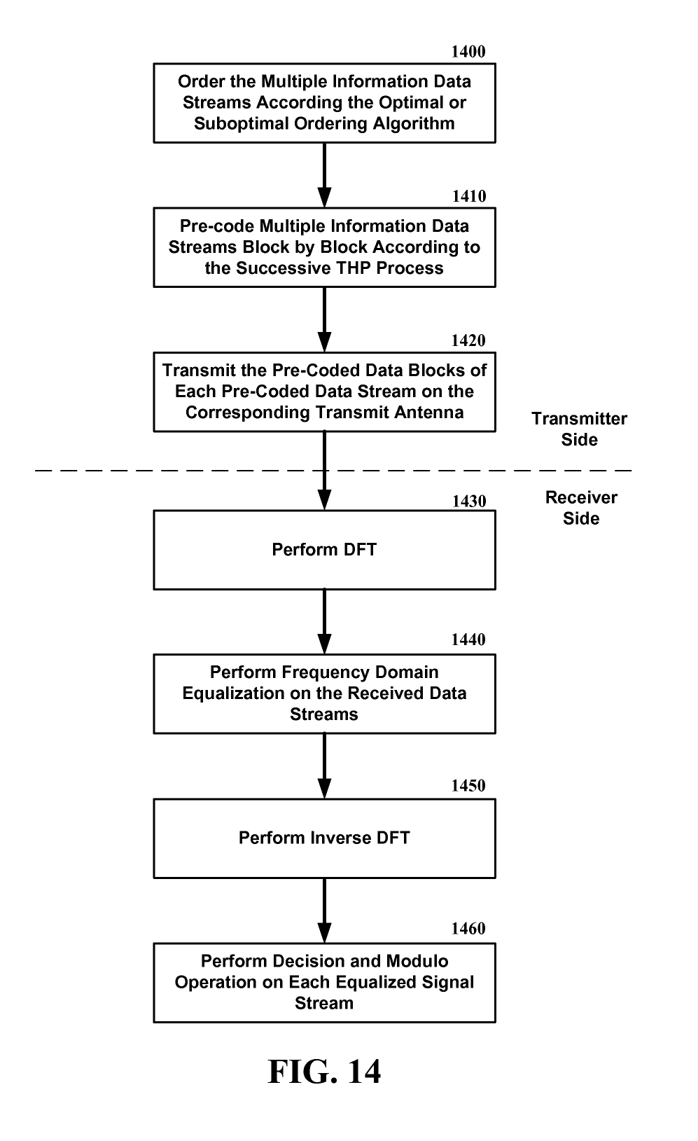

FIG. 14 further illustrates a general flow diagram for the successive THP-FDE technique wherein, on the transmitter side, information data streams are ordered according to an optimal, or suboptimal, order at 1400. At 1410, the information data streams are pre-coded block by block according to the successive THP process described above. At 1420, the pre-coded blocks of each precoded data stream are transmitted to the receiver on a corresponding transmit antenna. Then, on the receiver side, among other things, at 1430, a DFT is taken on the data streams to ready the streams for equalization at 1440. At 1450, the inverse DFT can then be performed on the data streams. Finally, at 1460, the equalized data streams are passed to the decision and modulo components to retrieve the original information data streams.

In this regard, with the successive THP-FDE technique, an optimal ordering algorithm can be adopted in the sense of minimizing the maximum of MMSEs. Simulation results have demonstrated the significant performance improvement of the THP-FDE MIMO techniques compared to the conventional FDE MIMO techniques. Furthermore, it has been shown that by applying channel prediction and THP compensation, the THP-FDE techniques become almost insensitive to channel variations and may therefore be considered as a practical FDE structure for future broadband wireless systems.

### Proof of Optimality of MMSE Ordering Algorithm

The proof of the optimality described above is now described in non-limiting fashion. Instead of optimizing by maximizing the minimum of post-detection SNRs, the precoding order is optimized by minimizing the maximum of MMSEs. Define Q≡{Q₁, Q₂, . . . , Q_{N}_{_{T}}} as an arbitrary precoding order. For the element Qᵢ, let it be defined that Qᵢ≡{Qᵢ₊₁, . . . , Q_{N}_{_{T}}} as its remaining set, which includes the elements (streams) that are precoded after Qᵢ. It is noted that Qᵢ is the hull set {φ} if i=N_{T}. Before optimality is shown, two lemmas are given.

Lemma 1.: Let A and B denote two distinct orders. If Aₖ=Bₖ and their remaining sets Aₖ and Bₖ consist of the same elements, then MMSE_{A}_{ₖ}=MMSE_{B}_{ₖ}.

Lemma 2.: Let A and B denote two distinct orders. If Aₖ=Bₗ and the remaining set of Aₖ, i.e., Aₖ, is a subset of the remaining set of Bₗ, i.e., Bₗ, then MMSE_{A}_{ₖ}≦MMSE_{B}_{ₗ}.

Proof: Since A and B are two distinct orders, B can be obtained from A by exchanging adjacent elements in A in finite times. Focusing on an arbitrary exchange of two adjacent elements in A, say elements Aᵢ and Aᵢ₊₁, the new order is defined as A′. If it can be shown that MMSE_{A}_{ₖ}=MMSE_{A′}_{ₖ} for k<i and k>i+1, then Lemma 1 will be proved. If it can be shown that MMSE_{A}_{ₖ}≧MMSE_{A′}_{ₖ₊₁} and MMSE_{A}_{ₖ₊₁}≦MMSE_{A′}_{ₖ}, then by combining this result with Lemma 1, Lemma 2 will follow.

From Equations (19) and (21), it can be observed that the MMSE value of a particular transmit stream p is proportional to the p-th diagram element in D, i.e., Dₚₚ. Thus, the comparison of the MMSE values of different streams is equivalent to that of their corresponding diagonal elements in D. The matrix R₁₁⁻¹ is defined in Equation (20) as R_{11,A}⁻¹ and R_{11,A′}⁻¹ for order A and order A′, respectively. Define the Chelosky factorization of R_{11,A}⁻¹ as R_{11,A}⁻¹≡LDL^{H}. Since A′ is obtained by exchanging the elements Aᵢ and Aᵢ₊₁, R_{11,A}⁻¹ is obtained as Equation (42):

R_{11,A′}⁻¹=PR_{11,A}⁻¹P=(PLP)PDP(PLP)^{H}≡L′D′(L′)^{H} (42)

where P is the permutation matrix, where row i and row i+1 of the matrix R_{11,A}⁻¹ will be exchanged when it is pre-multiplied by P. Define C according to Equation (43):

$$C ≡ [ \begin{matrix}{I}_{i - 1} & 0 & 0 & 0 \\ 0 & 1 & - {L}_{( i + 1 ) i} & 0 \\ 0 & 0 & 1 & 0 \\ 0 & 0 & 0 & {I}_{{N}_{T} - i - 1}\end{matrix} ] . \qquad ( 43 )$$

By multiplying L′ by C, a lower triangular matrix \hat{L}=L′C, whose diagonal elements are all equal to 1. By replacing L′ with \hat{L} in (42), Equation (44) is obtained as follows:

$${R}_{11 , {\underline{A}}^{′}}^{- 1} = \hat{L} [ \begin{matrix}{D}_{1 \text{:} ( i - 1 )} & 0 & 0 \\ 0 & G & 0 \\ 0 & 0 & {D}_{( i + 2 ) \text{:} {N}_{T}}\end{matrix} ] {\hat{L}}^{H} \qquad ( 44 )$$

where the notation D_{p:q} denote the square submatrix of D whose elements are drawn from row p column p to row q column q of the matrix D. Likewise, in Equation (44), G is given by Equation (45):

$$G = [ \begin{matrix}{G}_{11} & {L}_{( i + 1 ) i} {D}_{i i} \\ {L}_{( i + 1 ) i}^{*} {D}_{i i} & {D}_{i i}\end{matrix} ] . \qquad ( 45 )$$

where G₁₁≡D₍ᵢ₊₁₎₍ᵢ₊₁₎+|L₍ᵢ₊₁₎ᵢ|² Dᵢᵢ. Defining the Chelosky factorization of G as G≡L_{G}D_{G}L_{G}^{II}, Equation (46) can be obtained:

$${D}_{G} = [ \begin{matrix}{G}_{11} & 0 \\ 0 & {D}_{i i} - \frac{{\vert {L}_{( i + 1 ) i} \vert}^{2} {D}_{i i}^{2}}{{G}_{11}}\end{matrix} ] . \qquad ( 46 )$$

Likewise, the Chelosky factorization of R_{11,A′}⁻¹ is defined as R_{11,A′}⁻¹≡ [symbol] ^{H}, then by substituting G≡L_{G}D_{G}L_{G}^{H} and Equation (46) into Equation (44) and after some manipulations, the Chelosky factorization of G is obtained. Due to the uniqueness of the Chelosky factorization, Equation (47) results as follows:

$$= [ \begin{matrix}{D}_{1 \text{:} ( i - 1 )} & 0 & 0 \\ 0 & {D}_{G} & 0 \\ 0 & 0 & {D}_{( i + 2 ) \text{:} {N}_{T}}\end{matrix} ] . \qquad ( 47 )$$

It can be seen from Equation (47) that Dₖₖ=Dₖₖ for k<i and k>i+1. This proves Lemma 1.

Since Dₖₖ>0 for k=1, . . . , N_{T}, relationships (48) and (49) can be shown from Equation (46):

$$\begin{matrix}0 < {( i + 1 ) ( i + 1 )}_{} = {D}_{i i} - \frac{{\vert {L}_{( i + 1 ) i} \vert}^{2} {D}_{i i}^{2}}{□} \leq {D}_{i i} & ( 48 ) \\ 0 < {D}_{( i + 1 ) ( i + 1 )} < {i i}_{} = {G}_{11} . & ( 49 )\end{matrix}$$

Thus, MMSE_{A′}_{ᵢ₊₁}≦MMSE_{A}_{ᵢ} and MMSE_{A}_{ᵢ₊₁}≦MMSE_{A′}_{ᵢ}. By combining this result and Lemma 1, Lemma 2 follows.

With respect to proof of the optimality, G≡{G₁, G₂, . . . , G_{N}_{_{T}}} is defined as the order obtained by the algorithm in Table 1 and Q≡{Q₁, Q₂, . . . , Q_{N}_{_{T}}} denotes an arbitrary order distinct from G. Define d as the index of the first element for which Q differs from G. Thus, Gᵢ=Qᵢ for 1≦i≦d−1. Let r be the index where G_{d}=Qᵣ. By moving the element Qᵣ to the position between Q_{d-1} and Q_{d} in Q, a new order is obtained as follows:

$$\begin{matrix}{\underline{Q}}^{′} ≡ \{ {Q}_{1}^{′} , … , {Q}_{d - 1}^{′} , {Q}_{d}^{′} , {Q}_{d + 1}^{′} , … , {Q}_{r - 1}^{′} , {Q}_{r}^{′} , … , {Q}_{{N}_{T}}^{′} \} \\ = \{ {Q}_{1} , … , {Q}_{d - 1} , {Q}_{r} , {Q}_{d} , … , {Q}_{r - 1} , {Q}_{r + 1} , … , {Q}_{{N}_{T}} \} .\end{matrix}$$

By using Lemma 1, MMSE_{Q}_{ᵢ}=MMSE_{Q′}ᵢ for 1≦i≦d−1 and for r+1≦i≦N_{T}. By using Lemma 2, MMSE_{Q}_{ᵢ}≧MMSE_{Q′}_{ᵢ₊₁} for d≦i≦r−1. It can also be proved from Lemma 2 that MMSE_{Q}_{ᵣ}≦MMSE_{Q′}_{_{d}}. Since Q′_{d}=G_{d} and G_{d} is the one that has the minimum MMSE value in that iteration step, MMSE_{Q}_{_{d}}≧MMSE_{Q′}_{_{d}}. Thus, MMSE_{Q}_{_{d}}≧MMSE_{Q}ᵢ. By considering the above comparison results, Equation (50) results:

$${max}_{i} M M S {E}_{{Q}_{i}} \geq {max}_{i} M M S {E}_{{Q}_{i}^{′}} . \qquad ( 50 )$$

By repeating the above procedure, G is finally obtained while the maximum MMSE value in each intermediate step is no larger than the one in the previous step. That is, Equation (51) pertains:

$${max}_{i} M M S {E}_{{Q}_{i}} \geq {max}_{i} M M S {E}_{{Q}_{i}^{′}} \geq … \geq {max}_{i} M M S {E}_{{G}_{i}} . \qquad ( 51 )$$

Since Q is an arbitrary order distinct from G, it has been shown that the algorithm leads to the global optimal order in the sense of minimizing the maximum of MMSEs over all possible orders.

### Non-Limiting Operating Environments and Apparatus

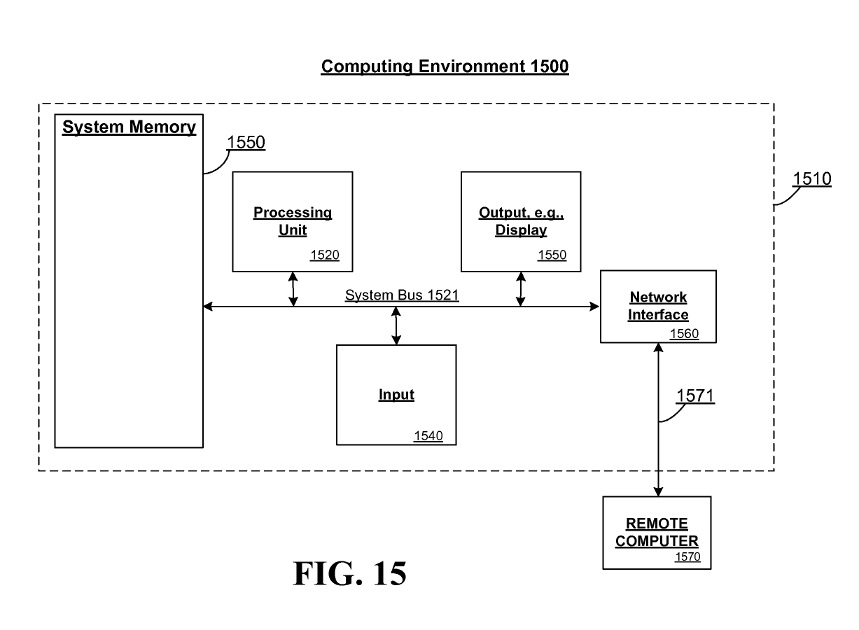

Turning to FIG. 15, an exemplary non-limiting computing system or operating environment in which the present invention may be implemented is illustrated. One of ordinary skill in the art can appreciate that handheld, portable and other computing devices and computing objects of all kinds are contemplated for use in connection with the present invention, i.e., anywhere that a communications system may be desirably configured. Accordingly, the below general purpose remote computer described below in FIG. 15 is but one example of a computing system in which the present invention may be implemented.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 15 thus illustrates an example of a suitable computing system environment 1500 in which the invention may be implemented, although as made clear above, the computing system environment 1500 is only one example of a suitable computing environment for a media device and is not intended to suggest any limitation as to the scope of use or functionality of the invention. Neither should the computing environment 1500 be interpreted as having any dependency or requirement relating to any one or combination of components illustrated in the exemplary operating environment 1500.

With reference to FIG. 15, an example of a computing environment 1500 for implementing the invention includes a general purpose computing device in the form of a computer 1510. Components of computer 1510 may include, but are not limited to, a processing unit 1520, a system memory 1530, and a system bus 1521 that couples various system components including the system memory to the processing unit 1520. The system bus 1521 may be any of several types of bus structures including a memory bus or memory controller, a peripheral bus, and a local bus using any of a variety of bus architectures.

Computer 1510 typically includes a variety of computer readable media. Computer readable media can be any available media that can be accessed by computer 1510. By way of example, and not limitation, computer readable media may comprise computer storage media and communication media. Computer storage media includes volatile and nonvolatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1510. Communication media typically embodies computer readable instructions, data structures, program modules or other data in a modulated data signal such as a carrier wave or other transport mechanism and includes any information delivery media.

The system memory 1530 may include computer storage media in the form of volatile and/or nonvolatile memory such as read only memory (ROM) and/or random access memory (RAM). A basic input/output system (BIOS), containing the basic routines that help to transfer information between elements within computer 1510, such as during start-up, may be stored in memory 1530. Memory 1530 typically also contains data and/or program modules that are immediately accessible to and/or presently being operated on by processing unit 1520. By way of example, and not limitation, memory 1530 may also include an operating system, application programs, other program modules, and program data.

The computer 1510 may also include other removable/non-removable, volatile/nonvolatile computer storage media. For example, computer 1510 could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1521 through a non-removable memory interface such as an interface, and a magnetic disk drive or optical disk drive is typically connected to the system bus 1521 by a removable memory interface, such as an interface.

A user may enter commands and information into the computer 1510 through input devices such as a keyboard and pointing device, commonly referred to as a mouse, trackball or touch pad. Other input devices may include a microphone, joystick, game pad, satellite dish, scanner, or the like. These and other input devices are often connected to the processing unit 1520 through user input 1540 and associated interface(s) that are coupled to the system bus 1521, but may be connected by other interface and bus structures, such as a parallel port, game port or a universal serial bus (USB). A graphics subsystem may also be connected to the system bus 1521. A monitor or other type of display device is also connected to the system bus 1521 via an interface, such as output interface 1550, which may in turn communicate with video memory. In addition to a monitor, computers may also include other peripheral output devices such as speakers and a printer, which may be connected through output interface 1550.

The computer 1510 may operate in a networked or distributed environment using logical connections to one or more other remote computers, such as remote computer 1570, which may in turn have media capabilities different from device 1510. The remote computer 1570 may be a personal computer, a server, a router, a network PC, a peer device or other common network node, or any other remote media consumption or transmission device, and may include any or all of the elements described above relative to the computer 1510. The logical connections depicted in FIG. 15 include a network 1571, such local area network (LAN) or a wide area network (WAN), but may also include other networks/buses. Such networking environments are commonplace in homes, offices, enterprise-wide computer networks, intranets and the Internet.

When used in a LAN networking environment, the computer 1510 is connected to the LAN 1571 through a network interface or adapter. When used in a WAN networking environment, the computer 1510 typically includes a communications component, such as a modem, or other means for establishing communications over the WAN, such as the Internet. A communications component, such as a modem, which may be internal or external, may be connected to the system bus 1521 via the user input interface of input 1540, or other appropriate mechanism. In a networked environment, program modules depicted relative to the computer 1510, or portions thereof, may be stored in a remote memory storage device. It will be appreciated that the network connections shown and described are exemplary and other means of establishing a communications link between the computers may be used.

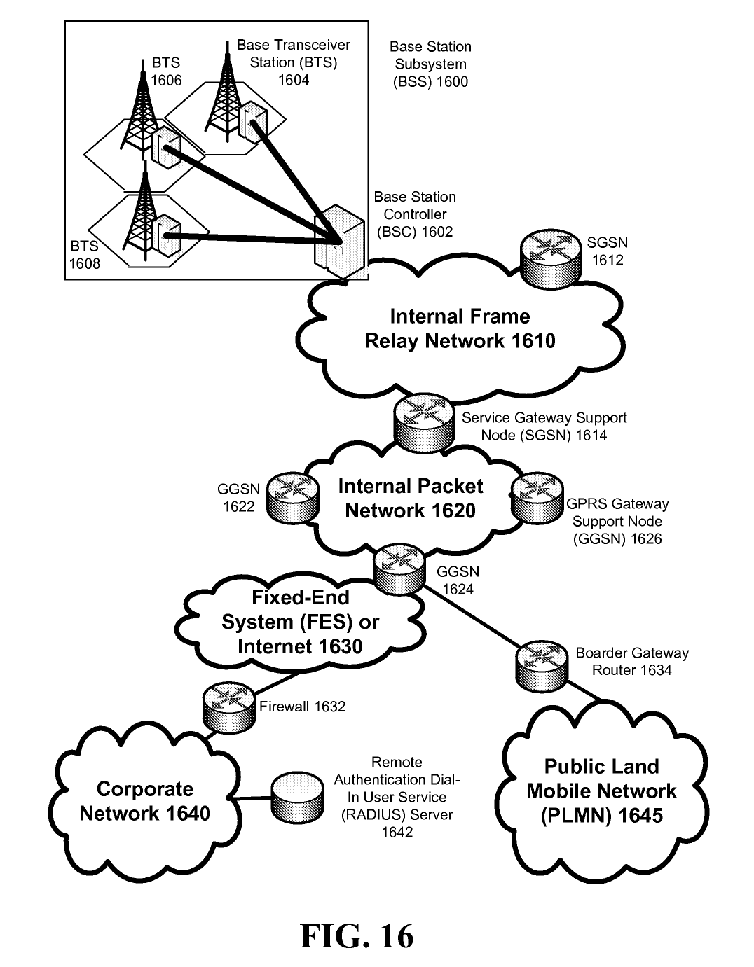

Turning now to FIG. 16, an overview of a network environment suitable for service by embodiments of the invention is illustrated. The above-described systems and methodologies for channel equalization may be applied to any network; however, the following description sets forth some exemplary telephony radio networks and non-limiting operating environments for the present invention. The below-described operating environments should be considered non-exhaustive, however, and thus the below-described network architecture is merely one network architecture into which the present invention may be incorporated. It is to be appreciated that the invention may be incorporated into any now existing or future alternative architectures for communication networks as well.

The global system for mobile communication (“GSM”) is one of the most widely utilized wireless access systems in today's fast growing communications systems. GSM provides circuit-switched data services to subscribers, such as mobile telephone or computer users. General Packet Radio Service (“GPRS”), which is an extension to GSM technology, introduces packet switching to GSM networks. GPRS uses a packet-based wireless communication technology to transfer high and low speed data and signaling in an efficient manner. GPRS optimizes the use of network and radio resources, thus enabling the cost effective and efficient use of GSM network resources for packet mode applications.

As one of ordinary skill in the art can appreciate, the exemplary GSM/GPRS environment and services described herein can also be extended to 3G services, such as Universal Mobile Telephone System (“UMTS”), Frequency Division Duplexing (“FDD”) and Time Division Duplexing (“TDD”), High Speed Packet Data Access (“HSPDA”), cdma2000 1× Evolution Data Optimized (“EVDO”), Code Division Multiple Access-2000 (“cdma2000 3×”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that shall become available in time. In this regard, the techniques of the invention may be applied independently of the method of data transport, and does not depend on any particular network architecture, or underlying protocols.

FIG. 16 depicts an overall block diagram of an exemplary packet-based mobile cellular network environment, such as a GPRS network, in which the invention may be practiced. In such an environment, there are a plurality of Base Station Subsystems (“BSS”) 1600 (only one is shown), each of which comprises a Base Station Controller (“BSC”) 1602 serving a plurality of Base Transceiver Stations (“BTS”) such as BTSs 1604, 1606, and 1608. BTSs 1604, 1606, 1608, etc., are the access points where users of packet-based mobile devices become connected to the wireless network. In exemplary fashion, the packet traffic originating from user devices is transported over the air interface to a BTS 1608, and from the BTS 1608 to the BSC 1602. Base station subsystems, such as BSS 1600, are a part of internal frame relay network 1610 that may include Service GPRS Support Nodes (“SGSN”) such as SGSN 1612 and 1614. Each SGSN is in turn connected to an internal packet network 1620 through which a SGSN 1612, 1614, etc., can route data packets to and from a plurality of gateway GPRS support nodes (GGSN) 1622, 1624, 1626, etc. As illustrated, SGSN 1614 and GGSNs 1622, 1624, and 1626 are part of internal packet network 1620. Gateway GPRS serving nodes 1622, 1624 and 1626 mainly provide an interface to external Internet Protocol (“IP”) networks such as Public Land Mobile Network (“PLMN”) 1645, corporate intranets 1640, or Fixed-End System (“FES”) or the public Internet 1630. As illustrated, subscriber corporate network 1640 may be connected to GGSN 1624 via firewall 1632; and PLMN 1645 is connected to GGSN 1624 via boarder gateway router 1634. The Remote Authentication Dial-In User Service (“RADIUS”) server 1642 may be used for caller authentication when a user of a mobile cellular device calls corporate network 1640.

Generally, there can be four different cell sizes in a GSM network—macro, micro, pico and umbrella cells. The coverage area of each cell is different in different environments. Macro cells can be regarded as cells where the base station antenna is installed in a mast or a building above average roof top level. Micro cells are cells whose antenna height is under average roof top level; they are typically used in urban areas. Pico cells are small cells having a diameter is a few dozen meters; they are mainly used indoors. On the other hand, umbrella cells are used to cover shadowed regions of smaller cells and fill in gaps in coverage between those cells.

The present invention has been described herein by way of examples. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

Additionally, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The terms “article of manufacture,” “computer program product” or similar terms, where used herein, are intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, according to various permutations and combinations of the foregoing. Sub-components can also be implemented as components communicatively coupled to other components rather than included within parent components, e.g., according to a hierarchical arrangement. Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

What is claimed is:

1. A system that facilitates channel equalization in a multiple-input multiple-output (MIMO) communication system, comprising:
a transmitter component including a preceding component that pre-codes N_{T} information data streams and generates N_{T} precoded data streams; and
a receiver component including a frequency domain equalizer (FDE) component that equalizes N_{R} received data streams and one or more combined decision and modulo-operation components to retrieve the N_{T} information data streams.

2. The system of claim 1, wherein the precoding component is a Tomlinson-Harashima precoding (THP) component, comprising:
a N_{fb}-order feedback filter, with N_{T} inputs and N_{T} outputs, that pre-codes the N_{T} information data streams and generates N_{T} filtered data streams based on previously pre-coded symbols of precoded data streams; and
one or more modulo operators generate symbols of the precoded data streams by performing a modulo operation on the symbols in the N_{T} filtered data streams to limit a signal amplitude of the precoded symbols into a restricted region.

3. The system of claim 2, wherein the THP component inserts N_{fb} zeros in each block of the precoded data streams to initialize the N_{fb}-order feedback filter.

4. The system of claim 1, wherein the precoding component inserts a cyclic prefix (CP) in each block of the precoded data streams to remove inter-block interference and to transform a linear convolution with the channel to a circular convolution.

5. The system of claim 1, wherein the receiver component comprises:
a frequency domain equalizer (FDE) component that equalizes N_{R} received data streams that are received from N_{R} receive antennas and generates N_{T} equalized data streams; and
one or more combined decision and modulo-operation components that retrieve the N_{T} information data streams from the N_{T} equalized data streams output from the FDE component.

6. The system of claim 1, wherein the preceding component at the transmitter and the frequency domain equalizer component at the receiver are jointly designed based on a minimum mean square error (MMSE) criterion.

7. The system of claim 1, wherein the receiver component further comprises:
a channel estimator that estimates channel state information (CSI) in every time slot;
a channel predictor that predicts the CSI of next time slots based on the estimated CSI in current and previous time slots by using an autoregressive (AR) model, and feeds back the predicted CSI to the transmitter component; and
a THP compensator that mitigates mismatch between the true CSI and the predicted CSI and provides coefficients for the FDE component.

8. The system of claim 1, wherein the preceding component further comprises an ordering component that orders the information data streams according to an optimal ordering and pre-codes the information data streams sequentially according to the optimal order.

9. The system of claim 8, wherein the ordering component determines the optimal order via an iterative process, whereby at each iteration step of the iterative process, a information data stream is selected that has the minimum mean square error (MMSE) of remaining unordered information data streams.

10. The system of claim 8, wherein the preceding component orders the information data streams by minimizing the maximum of MMSEₚ values over all possible orders, where MMSEₚ denotes the minimum mean square error (MMSE) value of the p-th information data stream in an order.

11. The system of claim 8, wherein the preceding component pre-codes a current data stream of the optimal order of the information data streams based on previously pre-coded symbols of precoded data streams.

12. The system of claim 1, wherein the preceding component further comprises an ordering component that orders the information data streams according to a sub-optimal order that orders the information data streams according to their minimum mean square errors (MMSEs), which are calculated by setting N_{fb}=0.

13. The system of claim 12, wherein the preceding component pre-codes a current data stream of the sub-optimal order of the information data streams based on previously pre-coded symbols of precoded data streams.

14. A method for wireless communication according to a multiple-input multiple-output (MIMO) communication system, comprising:
pre-coding N_{T} information data streams with a Tomlinson-Harashima preceding (THP) component before transmitting the N_{T} pre-coded data streams to respective transmitters of a transmitter component of a MIMO system; and
equalizing N_{R} received data streams with each of them being from one receive antenna of a receiver component of the MIMO system with a frequency domain equalizer (FDE) component to generate N_{T} equalized data streams; and
identifying the N_{T} information data streams from the N_{T} equalized data streams including processing the equalized data streams with a combined decision and modulo-operation component.

15. The method of claim 14, wherein the pre-coding and equalizing steps are jointly optimized based on a minimum mean square error (MMSE) criterion.

16. The method of claim 14, further comprising:
determining an optimal order for the N_{T} information data streams; and
wherein the precoding further includes pre-coding the N_{T} information data streams according to the optimal order.

17. The method of claim 14, further comprising:
determining a sub-optimal order for the N_{T} information data streams; and
wherein the pre-coding includes pre-coding the N_{T} information data streams in the sub-optimal order.

18. The method of claim 14, wherein the equalizing of the N_{R} received data streams includes:
obtaining the N_{R} received data streams in the time domain from N_{R} receive antennas of the received component;
first converting the received data streams to the frequency domain using a discrete Fourier transform (DFT) operation;
equalizing the N_{R} received data streams in the frequency domain to generate N_{T} equalized data streams; and
second converting the N_{T} equalized data streams to the time domain using an inverse discrete Fourier transform (IDFT) operation.

19. The method of claim 18, wherein the first converting using the DFT operation includes using a fast Fourier transform (FFT) algorithm and the second converting using the IDFT operation includes using an inverse fast Fourier transform (IFFT) algorithm.

20. The method of claim 14, further comprising:
estimating the channel state information (CSI) at the receiver side of a current time slot;
predicting the CSI of a next time slot based on estimated CSIs of current and previous time slots by using an autoregressive (AR) model and optimizing prediction of the CSI of the next time slot in the least square (LS) sense to form predicted CSI;
feeding the predicted CSI back to the transmitter component; and
compensating for any mismatch between the predicted CSI and true CSI when calculating coefficients of the FDE component for use during the equalizing step.

21. The method of claim 14, further comprising:
analyzing the performance of the equalizing step at least in part by determining an approximation for at least one bit error rate for the communication system based on a Modified Chernoff Approximation (MCA) algorithm.

22. An apparatus for communicating in a multiple-input multiple-output (MIMO) communication system, including:
a transmitter component, cooperating with the at least one processor, wherein the transmitter component includes a pre-coding component that pre-codes N_{T} data streams in the time domain for transmitting to other apparatus; and
a receiver component, cooperating with the at least one processor, wherein the receiver component includes at least one frequency domain equalization component that equalizes N_{R} received data streams from the other apparatus and wherein the receiver component further includes one or more combined decision and modulo operators that retrieve original information data streams from the equalized data streams.

23. The apparatus of claim 22, wherein the transmitter component further includes an ordering component that orders the N_{T} information data streams according to an optimal order based on minimizing maximum minimum mean-square-error (MMSE) values determined by the transmitter component.

24. The apparatus of claim 22, wherein the transmitter component further includes an ordering component that orders the N_{T} information data streams according to a suboptimal order based on the minimum mean-square-error (MMSE) values calculated by setting N_{fb}=0.

25. The apparatus of claim 22, wherein the receiver component further includes
a channel estimation component that estimates a true channel state information (CSI) value at each current time slot of the received signal streams to form an estimated CSI value;
a channel prediction component that predicts a CSI value of a next time slot based on the estimated CSI value of the current time slot and based on the estimated CSI values of previous time slots; and
a THP compensation component that mitigates any mismatch between the predicted CSI value and the true CSI value when calculating coefficients for the FDE component.
